(19) United States
(12) Patent Application Publication
(10) Pub. No.: US 2023/0247651 A1
(43) Pub. Date: Aug. 3, 2023

(54) TECHNIQUES FOR SIDELINK RESOURCE EXCLUSION WITH A MULTI-TRANSMISSION AND RECEIVE POINT (TRP) ENABLED TRANSMITTER

(71) Applicant: QUALCOMM Incorporated, San Diego, CA (US)

(72) Inventors: Sourjya DUTTA, San Diego, CA (US); Kapil GULATI, Belle Mead, NJ (US); Junyi LI, Fairless Hills, PA (US); Shuanshuan WU, San Diego, CA (US); Hui GUO, Beijing (CN)

(21) Appl. No.: 18/003,616

(22) PCT Filed: Sep. 4, 2020
(86) PCT No.: PCT/CN2020/113487

§ 371 Date: Dec. 28, 2022

(51) Int. Cl. H04W 72/25; H04W 28/26; H04W 72/0446; H04W 72/0453; H04W 72/54; H04W 72/563

(52) U.S. Cl. CPC H04W 72/25; H04W 28/26; H04W 72/0446; H04W 72/0453; H04W 72/54; H04W 72/563

(57) ABSTRACT

Methods, systems, and devices for wireless communications are described. A first user equipment (UE) may receive, from a second UE a sidelink control information transmission associated with a first transmission configuration indicator (TCI) state over a sidelink channel. The first UE may determine that the sidelink control information transmission reserves time and frequency resources for a sidelink data transmission associated with a second TCI state. In some examples, the second TCI state may be different from the first TCI state. The first UE may then selectively enable or disable a resource protection procedure for the reserved time and frequency resources based on the determination and a signal strength associated with the first TCI state or the second TCI state, a network congestion parameter, or a data priority associated with the sidelink data transmission.

### CROSS REFERENCE

The present application is a 371 national stage filing of International PCT Application No. PCT/CN2020/113487 by Dutta et al. entitled “TECHNIQUES FOR SIDELINK RESOURCE EXCLUSION WITH A MULTI-TRANSMISSION AND RECEIVE POINT (TRP) ENABLED TRANSMITTER,” filed Sep. 4, 2020, which is assigned to the assignee hereof, and which is expressly incorporated by reference in its entirety herein.

### FIELD OF TECHNOLOGY

The following relates to wireless communications, including techniques for sidelink resource exclusion with a multi-transmission and receive point (TRP) enabled transmitter.

### BACKGROUND

Wireless communications systems are widely deployed to provide various types of communication content such as voice, video, packet data, messaging, broadcast, and so on. These systems may be capable of supporting communication with multiple users by sharing the available system resources (e.g., time, frequency, and power). Examples of such multiple-access systems include fourth generation (4G) systems such as Long Term Evolution (LTE) systems, LTE-Advanced (LTE-A) systems, or LTE-A Pro systems, and fifth generation (5G) systems which may be referred to as New Radio (NR) systems. These systems may employ technologies such as code division multiple access (CDMA), time division multiple access (TDMA), frequency division multiple access (FDMA), orthogonal frequency division multiple access (OFDMA), or discrete Fourier transform spread orthogonal frequency division multiplexing (DFT-S-OFDM). A wireless multiple-access communications system may include one or more base stations or one or more network access nodes, each simultaneously supporting communication for multiple communication devices, which may be otherwise known as user equipment (UE).

In some wireless communications systems, wireless devices, such as user equipments (UEs), may include multiple TRPs. In some cases, the respective TRPs may include different quantities of other wireless devices to which they are connected. Moreover, radio conditions and physical obstructions may cause one TRP to have a lower quality link quality than another TRP.

### SUMMARY

The described techniques relate to improved methods, systems, devices, and apparatuses that support techniques for sidelink resource exclusion with a multi-transmission and receive point (TRP) enabled transmitter. Generally, the described techniques provide for multi-TRP UEs to reserve resources for future transmission for multiple TRPs. In some aspects, a UE may include multiple TRPs and may send transmissions, where each transmission may be associated with one or more transmission configuration indicator (TCI) states. A multi-TRP UE may reserve transmission resources for future transmissions by signaling a sidelink control information. In some aspects, a multi-TRP UE may be configured to use sidelink control information associated with a first TCI state to reserve resources for a second TCI state. In some aspects, a receiver UE may receive the sidelink control information associated with the first TCI state, and may determine that the sidelink control information transmission reserves time and frequency resources for a sidelink data transmission associated with the second TCI state. For instance, the receiver UE may determine that the sidelink control information associated with a first TRP reserves future time and frequency resources for a second TRP. The receiver UE may then enable or disable resource protection for the reserved time and frequency resources for the second TCI state based on a number of parameters.

A method of wireless communication at a first UE is described. The method may include receiving, from a second UE a sidelink control information transmission associated with a first TCI state over a sidelink channel, determining that the sidelink control information transmission reserves time and frequency resources for a sidelink data transmission associated with a second TCI state, the second TCI state being different from the first TCI state, and selectively enabling or disabling a resource protection procedure for the reserved time and frequency resources based on the determination and one or more of: a signal strength associated with the first TCI state or the second TCI state, a network congestion parameter, or a data priority associated with the sidelink data transmission.

An apparatus for wireless communication at a first UE is described. The apparatus may include a processor, memory coupled with the processor, and instructions stored in the memory. The instructions may be executable by the processor to cause the apparatus to receive, from a second UE a sidelink control information transmission associated with a first TCI state over a sidelink channel, determine that the sidelink control information transmission reserves time and frequency resources for a sidelink data transmission associated with a second TCI state, the second TCI state being different from the first TCI state, and selectively enable or disabling a resource protection procedure for the reserved time and frequency resources based on the determination and one or more of: a signal strength associated with the first TCI state or the second TCI state, a network congestion parameter, or a data priority associated with the sidelink data transmission.

Another apparatus for wireless communication at a first UE is described. The apparatus may include means for receiving, from a second UE a sidelink control information transmission associated with a first TCI state over a sidelink channel, determining that the sidelink control information transmission reserves time and frequency resources for a sidelink data transmission associated with a second TCI state, the second TCI state being different from the first TCI state, and selectively enabling or disabling a resource protection procedure for the reserved time and frequency resources based on the determination and one or more of: a signal strength associated with the first TCI state or the second TCI state, a network congestion parameter, or a data priority associated with the sidelink data transmission.

A non-transitory computer-readable medium storing code for wireless communication at a first UE is described. The code may include instructions executable by a processor to receive, from a second UE a sidelink control information transmission associated with a first TCI state over a sidelink channel, determine that the sidelink control information transmission reserves time and frequency resources for a sidelink data transmission associated with a second TCI state, the second TCI state being different from the first TCI state, and selectively enable or disabling a resource protection procedure for the reserved time and frequency resources based on the determination and one or more of: a signal strength associated with the first TCI state or the second TCI state, a network congestion parameter, or a data priority associated with the sidelink data transmission.

Some examples of the method, apparatuses, and non-transitory computer-readable medium described herein may further include operations, features, means, or instructions for identifying the signal strength associated with the second TCI state, the signal strength including a reference signal received power associated with the reserved time and frequency resources, and determining that the reference signal received power satisfies a threshold, where selectively enabling or disabling the resource protection procedure includes disabling the resource protection procedure for the reserved time and frequency resources based on determining that the reference signal received power may be greater than the threshold.

Some examples of the method, apparatuses, and non-transitory computer-readable medium described herein may further include operations, features, means, or instructions for determining that the network congestion parameter associated with the sidelink channel satisfies a threshold, where selectively enabling or disabling the resource protection procedure includes disabling the resource protection procedure for the reserved time and frequency resources based on determining that the network congestion parameter associated with the sidelink channel satisfies the threshold.

Some examples of the method, apparatuses, and non-transitory computer-readable medium described herein may further include operations, features, means, or instructions for identifying a reference signal received power threshold associated with the reserved time and frequency resources, where selectively enabling or disabling the resource protection procedure includes enabling the resource protection procedure for the reserved time and frequency resources based on the reference signal received power threshold.

Some examples of the method, apparatuses, and non-transitory computer-readable medium described herein may further include operations, features, means, or instructions for performing one or more measurements on the sidelink control information transmission associated with the first TCI state, where selectively enabling or disabling the resource protection procedure includes enabling the resource protection procedure for the reserved time and frequency resources based on performing the one or more measurements on the sidelink control information transmission.

In some examples of the method, apparatuses, and non-transitory computer-readable medium described herein, the one or more measurements include a reference signal received power measurement for the first TCI state. Some examples of the method, apparatuses, and non-transitory computer-readable medium described herein may further include operations, features, means, or instructions for determining that the first TCI state may be associated with a first TRP at the second UE and the second TCI may be associated with a second TRP at the second UE, and determining a reference signal received power offset between the first TRP and the second TRP based on one or more prior transmissions received from the first TRP or the second TRP or both, where selectively enabling or disabling the resource protection procedure includes enabling the resource protection procedure for the reserved time and frequency resources based on the reference signal received power offset between the first TRP and the second TRP.

Some examples of the method, apparatuses, and non-transitory computer-readable medium described herein may further include operations, features, means, or instructions for performing a reference signal received power measurement on the sidelink control information transmission associated with the first TCI state, and adjusting the reference signal received power measurement based on the reference signal received power offset, where the resource protection procedure may be based on the adjusted reference signal received power measurement.

In some examples of the method, apparatuses, and non-transitory computer-readable medium described herein, the one or more prior transmissions may be received within a threshold time period prior to receiving the sidelink control information transmission associated with the first TCI state.

Some examples of the method, apparatuses, and non-transitory computer-readable medium described herein may further include operations, features, means, or instructions for determining whether a destination identifier for the sidelink control information transmission may be same as a destination identifier for the one or more prior transmissions, where determining the reference signal received power offset may be based on the destination identifier for the sidelink control information transmission being the same as the destination identifier for the one or more prior transmissions.

In some examples of the method, apparatuses, and non-transitory computer-readable medium described herein, the one or more prior transmissions include at least one of broadcast transmissions, multicast transmissions, unicast transmissions, or a combination thereof. Some examples of the method, apparatuses, and non-transitory computer-readable medium described herein may further include operations, features, means, or instructions for performing a reference signal received power measurement on the sidelink control information transmission, and determining a threshold for the resource protection procedure for an upcoming reservation of time and frequency resources associated with the second TCI state based on the reference signal received power measurement on the sidelink control information transmission.

In some examples of the method, apparatuses, and non-transitory computer-readable medium described herein, the threshold includes a second reference signal received power greater than the measured reference signal received power. Some examples of the method, apparatuses, and non-transitory computer-readable medium described herein may further include operations, features, means, or instructions for identifying the data priority associated with the sidelink data transmission, where selectively enabling or disabling the resource protection procedure includes enabling the resource protection procedure for the reserved time and frequency resources based on based on the identified data priority.

Some examples of the method, apparatuses, and non-transitory computer-readable medium described herein may further include operations, features, means, or instructions for identifying the data priority associated with the sidelink data transmission, where selectively enabling or disabling the resource protection procedure includes disabling the resource protection procedure for the reserved time and frequency resources based on based on determining that the identified data priority fails to satisfy a threshold.

Some examples of the method, apparatuses, and non-transitory computer-readable medium described herein may further include operations, features, means, or instructions for determining that reception of the sidelink data transmission associated with the second TCI state may be unsuccessful, and determining a threshold for the resource protection procedure for an upcoming reservation of time and frequency resources associated with the second TCI state based on the unsuccessful reception of the sidelink data transmission, the threshold for the resource protection procedure for the upcoming reservation of time and frequency resources being greater than a threshold for the resource protection procedure for the reserved time and frequency resources.

Some examples of the method, apparatuses, and non-transitory computer-readable medium described herein may further include operations, features, means, or instructions for receiving, from the second UE the sidelink data transmission associated with the second TCI state, and determining a threshold for the resource protection procedure for an upcoming reservation of time and frequency resources associated with the second TCI state based on the successful reception of the sidelink data transmission. Some examples of the method, apparatuses, and non-transitory computer-readable medium described herein may further include operations, features, means, or instructions for disabling the resource protection procedure for the reserved time and frequency resources, and communicating over the reserved time and frequency resources based on disabling the resource protection procedure.

Some examples of the method, apparatuses, and non-transitory computer-readable medium described herein may further include operations, features, means, or instructions for determining a threshold for the resource protection procedure for an upcoming reservation of time and frequency resources associated with the second TCI state based on disabling the resource protection procedure for the reserved time and frequency resources, the threshold for the resource protection procedure for the upcoming reservation of time and frequency resources being greater than a threshold for the resource protection procedure for the reserved time and frequency resources.

Some examples of the method, apparatuses, and non-transitory computer-readable medium described herein may further include operations, features, means, or instructions for identifying one or more TCI state identifiers included in the sidelink control information transmission, and determining that the sidelink control information transmission reserves time and frequency resources for the sidelink data transmission associated with the second TCI state based on the one or more TCI state identifiers.

Some examples of the method, apparatuses, and non-transitory computer-readable medium described herein may further include operations, features, means, or instructions for identifying a bit included in the sidelink control information transmission, and determining that the sidelink control information transmission reserves time and frequency resources for the sidelink data transmission associated with the second TCI state based on a value of the bit. In some examples of the method, apparatuses, and non-transitory computer-readable medium described herein, the second UE includes a multi-TRP enabled transmitter.

A method of wireless communication at a first UE is described. The method may include configuring a sidelink control information transmission associated with a first TCI state to reserve time and frequency resources for a sidelink data transmission associated with a second TCI state, the sidelink control information transmission including an indication of the second TCI state and transmitting, to a second UE the sidelink control information transmission associated with the first TCI state over a sidelink channel.

An apparatus for wireless communication at a first UE is described. The apparatus may include a processor, memory coupled with the processor, and instructions stored in the memory. The instructions may be executable by the processor to cause the apparatus to configure a sidelink control information transmission associated with a first TCI state to reserve time and frequency resources for a sidelink data transmission associated with a second TCI state, the sidelink control information transmission including an indication of the second TCI state and transmit, to a second UE the sidelink control information transmission associated with the first TCI state over a sidelink channel.

Another apparatus for wireless communication at a first UE is described. The apparatus may include means for configuring a sidelink control information transmission associated with a first TCI state to reserve time and frequency resources for a sidelink data transmission associated with a second TCI state, the sidelink control information transmission including an indication of the second TCI state and transmitting, to a second UE the sidelink control information transmission associated with the first TCI state over a sidelink channel.

A non-transitory computer-readable medium storing code for wireless communication at a first UE is described. The code may include instructions executable by a processor to configure a sidelink control information transmission associated with a first TCI state to reserve time and frequency resources for a sidelink data transmission associated with a second TCI state, the sidelink control information transmission including an indication of the second TCI state and transmit, to a second UE the sidelink control information transmission associated with the first TCI state over a sidelink channel.

In some examples of the method, apparatuses, and non-transitory computer-readable medium described herein, configuring the sidelink control information transmission may include operations, features, means, or instructions for identifying a TCI state identifier associated with the second TCI state, and including the TCI state identifier in the sidelink control information transmission associated with the first TCI state.

In some examples of the method, apparatuses, and non-transitory computer-readable medium described herein, configuring the sidelink control information transmission may include operations, features, means, or instructions for including a bit in the sidelink control information transmission associated with the first TCI state, where a value of the bit includes an indication of reservation of the time and frequency resources for the sidelink data transmission associated with the second TCI state.

In some examples of the method, apparatuses, and non-transitory computer-readable medium described herein, the first TCI state may be associated with a first TRP at the first UE and the second TCI may be associated with a second TRP at the first UE. In some examples of the method, apparatuses, and non-transitory computer-readable medium described herein, the first UE includes a multi-TRP enabled transmitter.

### BRIEF DESCRIPTION OF THE DRAWINGS

FIG. 1 illustrates an example of a wireless communications system that supports techniques for sidelink resource exclusion with a multi-transmission and receive point (TRP) enabled transmitter in accordance with aspects of the present disclosure.

FIG. 2 illustrates an example of a wireless communications system that supports techniques for sidelink resource exclusion with a multi-TRP enabled transmitter in accordance with aspects of the present disclosure.

FIG. 3 illustrates an example of a wireless communications system that supports techniques for sidelink resource exclusion with a multi-TRP enabled transmitter in accordance with aspects of the present disclosure.

FIG. 4 illustrates an example of a process flow that supports techniques for sidelink resource exclusion with a multi-TRP enabled transmitter in accordance with aspects of the present disclosure.

FIGS. 5 and 6 show block diagrams of devices that support techniques for sidelink resource exclusion with a multi-TRP enabled transmitter in accordance with aspects of the present disclosure.

FIG. 7 shows a block diagram of a communications manager that supports techniques for sidelink resource exclusion with a multi-TRP enabled transmitter in accordance with aspects of the present disclosure.

FIG. 8 shows a diagram of a system including a device that supports techniques for sidelink resource exclusion with a multi-TRP enabled transmitter in accordance with aspects of the present disclosure.

FIGS. 9 through 12 show flowcharts illustrating methods that support techniques for sidelink resource exclusion with a multi-TRP enabled transmitter in accordance with aspects of the present disclosure.

### DETAILED DESCRIPTION

A wireless communications system may support both access links and sidelinks for communications between one or more communication devices. An access link may refer to a communication link between a UE and a base station. For example, an access link may support uplink signaling, downlink signaling, connection procedures, etc. A sidelink may refer to any communication link between similar wireless devices (e.g., a communication link between UEs, or a backhaul communication link between base stations). It is noted that while various examples provided herein are discussed for UE sidelink devices, such sidelink techniques may be used for any type of wireless devices that use sidelink communications. For example, a sidelink may support one or more of device-to-device (D2D) communications, vehicle-to-everything (V2X) or vehicle-to-vehicle (V2V) communications, message relaying, discovery signaling, beacon signaling, or other signals transmitted over-the-air from one UE to one or more other UEs.

In some wireless communications systems supporting sidelink communications, wireless devices, such as UEs, may include multiple transmission and receive point (TRPs). For example, some vehicles may include TRPs at the front and rear of the vehicle such that the TRPs are separated by 2-20 meters depending on the length of the vehicle. In some cases, the respective TRPs may include different quantities of other wireless devices to which they are connected (e.g., more traffic in front of a vehicle may cause a front TRP to have a higher quantity of wireless connections than a rear TRP). Moreover, radio conditions and physical obstructions may cause one TRP to have a lower quality link quality than another TRP. In some cases, a multi-TRP UE may send transmissions of the same packet from different TRPs. Each transmission may be associated with one or more transmission configuration indicator (TCI) states. A multi-TRP UE may reserve transmission resources for future transmissions by signaling a sidelink control information. However, some wireless communications systems may not enable multi-TRP UEs to reserve resources for future transmission for multiple TRPs.

Accordingly, to improve sidelink transmissions, one or more aspects of the present disclosure provide for enhanced techniques for sidelink transmission with a multi-TRP UE. In some aspects, a multi-TRP UE may be configured to use sidelink control information associated with a first TCI state (e.g., TCI-0) to reserve resources for a second TCI state (e.g., TCI-1). A receiver UE may receive the sidelink control information associated with TCI-0 (or associated with a first TRP) and may determine that the sidelink control information has reserved resources for TCI-1 (associated with a second TRP). One or more aspects of the present disclosure provides for techniques for the receiver UE to selectively enable or disable resource protection for the reserved resources for TCI-1 based on a number of parameters. In some examples, the parameters may include a signal strength associated with a first TCI state (e.g., TCI-0) or a second TCI state (e.g., TCI-1), a network congestion parameter, or a data priority associated with the sidelink data transmission. In one example, the receiver UE may determine to disable resource protection for the reserved resources for TCI-1 in loaded networks. Alternatively, the receiver UE may enable resource protection for the reserved resources for TCI-1 with a threshold reference signal received power. In some examples, the receiver UE may enable resource protection for the reserved resources for TCI-1 using the common reference signal received power as measured over the sidelink control information associated with TCI-0. By selectively enabling or disabling resource protection procedure, the receiver UE may effectively protect resources reserved for TCI-1 based on receiving a sidelink control information associated with TCI-0.

UEs having a capability of sidelink communications may utilize the techniques described herein to experience power saving, such as reduced power consumption and extended battery life while ensuring reliable and efficient communications in the group of UEs. Particular aspects of the subject matter described in this disclosure may be implemented to realize one or more of the following potential advantages. The techniques employed by the described UEs may provide benefits and enhancements to the operation of the UEs. For example, operations performed by the UEs may provide improvements to wireless operations. In some examples, the UEs may support high reliability and low latency communications, among other examples, in accordance with one or more aspects of the present disclosure. The described techniques may thus include features for improvements to power consumption, spectral efficiency, higher data rates and, in some examples, may promote enhanced efficiency for high reliability and low latency operations, among other benefits.

Aspects of the disclosure are initially described in the context of wireless communications systems. Aspects of the disclosure are further described in the context of process flows. Aspects of the disclosure are further illustrated by and described with reference to apparatus diagrams, system diagrams, and flowcharts that relate to techniques for sidelink resource exclusion with a multi-TRP enabled transmitter.

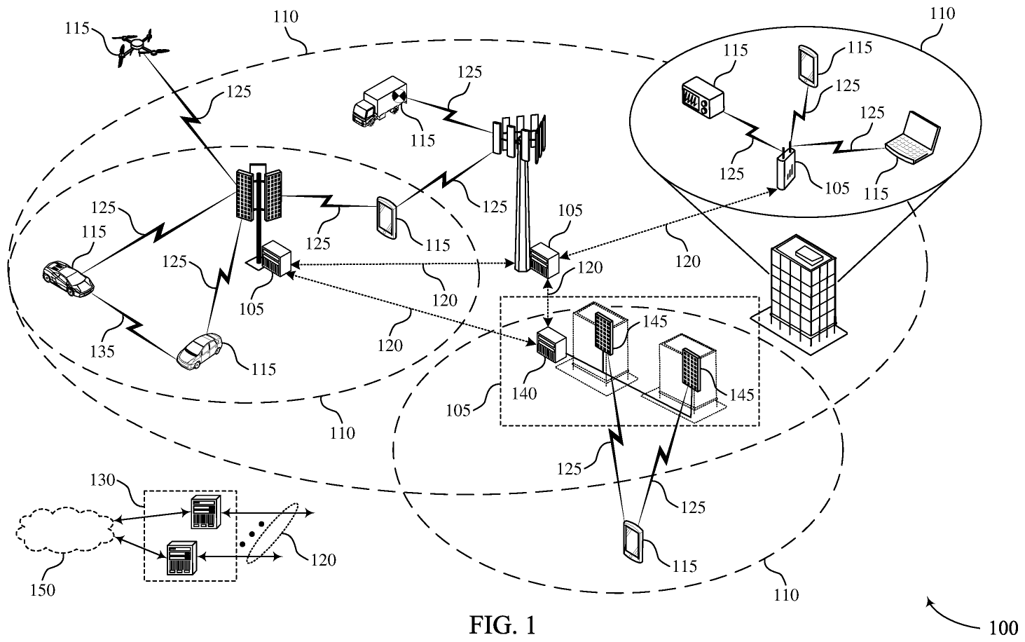

FIG. 1 illustrates an example of a wireless communications system 100 that supports techniques for sidelink resource exclusion with a multi-TRP enabled transmitter in accordance with aspects of the present disclosure. The wireless communications system 100 may include one or more base stations 105, one or more UEs 115, and a core network 130. In some examples, the wireless communications system 100 may be a Long Term Evolution (LTE) network, an LTE-Advanced (LTE-A) network, an LTE-A Pro network, or a New Radio (NR) network. In some examples, the wireless communications system 100 may support enhanced broadband communications, ultra-reliable (e.g., mission critical) communications, low latency communications, communications with low-cost and low-complexity devices, or any combination thereof.

The base stations 105 may be dispersed throughout a geographic area to form the wireless communications system 100 and may be devices in different forms or having different capabilities. The base stations 105 and the UEs 115 may wirelessly communicate via one or more communication links 125. Each base station 105 may provide a coverage area 110 over which the UEs 115 and the base station 105 may establish one or more communication links 125. The coverage area 110 may be an example of a geographic area over which a base station 105 and a UE 115 may support the communication of signals according to one or more radio access technologies.

The UEs 115 may be dispersed throughout a coverage area 110 of the wireless communications system 100, and each UE 115 may be stationary, or mobile, or both at different times. The UEs 115 may be devices in different forms or having different capabilities. Some example UEs 115 are illustrated in FIG. 1. The UEs 115 described herein may be able to communicate with various types of devices, such as other UEs 115, the base stations 105, or network equipment (e.g., core network nodes, relay devices, integrated access and backhaul (IAB) nodes, or other network equipment), as shown in FIG. 1.

The base stations 105 may communicate with the core network 130, or with one another, or both. For example, the base stations 105 may interface with the core network 130 through one or more backhaul links 120 (e.g., via an S1, N2, N3, or other interface). The base stations 105 may communicate with one another over the backhaul links 120 (e.g., via an X2, Xn, or other interface) either directly (e.g., directly between base stations 105), or indirectly (e.g., via core network 130), or both. In some examples, the backhaul links 120 may be or include one or more wireless links.

One or more of the base stations 105 described herein may include or may be referred to by a person having ordinary skill in the art as a base transceiver station, a radio base station, an access point, a radio transceiver, a NodeB, an eNodeB (eNB), a next-generation NodeB or a giga-NodeB (either of which may be referred to as a gNB), a Home NodeB, a Home eNodeB, or other suitable terminology.

A UE 115 may include or may be referred to as a mobile device, a wireless device, a remote device, a handheld device, or a subscriber device, or some other suitable terminology, where the “device” may also be referred to as a unit, a station, a terminal, or a client, among other examples. A UE 115 may also include or may be referred to as a personal electronic device such as a cellular phone, a personal digital assistant (PDA), a tablet computer, a laptop computer, or a personal computer. In some examples, a UE 115 may include or be referred to as a wireless local loop (WLL) station, an Internet of Things (IoT) device, an Internet of Everything (IoE) device, or a machine type communications (MTC) device, among other examples, which may be implemented in various objects such as appliances, or vehicles, meters, among other examples.

The UEs 115 described herein may be able to communicate with various types of devices, such as other UEs 115 that may sometimes act as relays as well as the base stations 105 and the network equipment including macro eNBs or gNBs, small cell eNBs or gNBs, or relay base stations, among other examples, as shown in FIG. 1.

The UEs 115 and the base stations 105 may wirelessly communicate with one another via one or more communication links 125 over one or more carriers. The term “carrier” may refer to a set of radio frequency spectrum resources having a defined physical layer structure for supporting the communication links 125. For example, a carrier used for a communication link 125 may include a portion of a radio frequency spectrum band (e.g., a bandwidth part (BWP)) that is operated according to one or more physical layer channels for a given radio access technology (e.g., LTE, LTE-A, LTE-A Pro, NR). Each physical layer channel may carry acquisition signaling (e.g., synchronization signals, system information), control signaling that coordinates operation for the carrier, user data, or other signaling. The wireless communications system 100 may support communication with a UE 115 using carrier aggregation or multi-carrier operation. A UE 115 may be configured with multiple downlink component carriers and one or more uplink component carriers according to a carrier aggregation configuration. Carrier aggregation may be used with both frequency division duplexing (FDD) and time division duplexing (TDD) component carriers.

In some examples (e.g., in a carrier aggregation configuration), a carrier may also have acquisition signaling or control signaling that coordinates operations for other carriers. A carrier may be associated with a frequency channel (e.g., an evolved universal mobile telecommunication system terrestrial radio access (E-UTRA) absolute radio frequency channel number (EARFCN)) and may be positioned according to a channel raster for discovery by the UEs 115. A carrier may be operated in a standalone mode where initial acquisition and connection may be conducted by the UEs 115 via the carrier, or the carrier may be operated in a non-standalone mode where a connection is anchored using a different carrier (e.g., of the same or a different radio access technology).

The communication links 125 shown in the wireless communications system 100 may include uplink transmissions from a UE 115 to a base station 105, or downlink transmissions from a base station 105 to a UE 115. Carriers may carry downlink or uplink communications (e.g., in an FDD mode) or may be configured to carry downlink and uplink communications (e.g., in a TDD mode).

A carrier may be associated with a particular bandwidth of the radio frequency spectrum, and in some examples the carrier bandwidth may be referred to as a “system bandwidth” of the carrier or the wireless communications system 100. For example, the carrier bandwidth may be one of a number of determined bandwidths for carriers of a particular radio access technology (e.g., 1.4, 3, 5, 10, 15, 20, 40, or 80 megahertz (MHz)). Devices of the wireless communications system 100 (e.g., the base stations 105, the UEs 115, or both) may have hardware configurations that support communications over a particular carrier bandwidth or may be configurable to support communications over one of a set of carrier bandwidths. In some examples, the wireless communications system 100 may include base stations 105 or UEs 115 that support simultaneous communications via carriers associated with multiple carrier bandwidths. In some examples, each served UE 115 may be configured for operating over portions (e.g., a sub-band, a BWP) or all of a carrier bandwidth.

Signal waveforms transmitted over a carrier may be made up of multiple subcarriers (e.g., using multi-carrier modulation (MCM) techniques such as orthogonal frequency division multiplexing (OFDM) or discrete Fourier transform spread OFDM (DFT-S-OFDM)). In a system employing MCM techniques, a resource element may consist of one symbol period (e.g., a duration of one modulation symbol) and one subcarrier, where the symbol period and subcarrier spacing are inversely related. The number of bits carried by each resource element may depend on the modulation scheme (e.g., the order of the modulation scheme, the coding rate of the modulation scheme, or both). Thus, the more resource elements that a UE 115 receives and the higher the order of the modulation scheme, the higher the data rate may be for the UE 115. A wireless communications resource may refer to a combination of a radio frequency spectrum resource, a time resource, and a spatial resource (e.g., spatial layers or beams), and the use of multiple spatial layers may further increase the data rate or data integrity for communications with a UE 115.

One or more numerologies for a carrier may be supported, where a numerology may include a subcarrier spacing (Δf) and a cyclic prefix. A carrier may be divided into one or more BWPs having the same or different numerologies. In some examples, a UE 115 may be configured with multiple BWPs. In some examples, a single BWP for a carrier may be active at a given time and communications for the UE 115 may be restricted to one or more active BWPs.

The time intervals for the base stations 105 or the UEs 115 may be expressed in multiples of a basic time unit which may, for example, refer to a sampling period of Tₛ=1/(Δfₘₐₓ·N_{f}) seconds, where Δfₘₐₓ may represent the maximum supported subcarrier spacing, and N_{f} may represent the maximum supported discrete Fourier transform (DFT) size. Time intervals of a communications resource may be organized according to radio frames each having a specified duration (e.g., 10 milliseconds (ms)). Each radio frame may be identified by a system frame number (SFN) (e.g., ranging from 0 to 1023).

Each frame may include multiple consecutively numbered subframes or slots, and each subframe or slot may have the same duration. In some examples, a frame may be divided (e.g., in the time domain) into subframes, and each subframe may be further divided into a number of slots. Alternatively, each frame may include a variable number of slots, and the number of slots may depend on subcarrier spacing. Each slot may include a number of symbol periods (e.g., depending on the length of the cyclic prefix prepended to each symbol period). In some wireless communications systems 100, a slot may further be divided into multiple mini-slots containing one or more symbols. Excluding the cyclic prefix, each symbol period may contain one or more (e.g., N_{f}) sampling periods. The duration of a symbol period may depend on the subcarrier spacing or frequency band of operation.

A subframe, a slot, a mini-slot, or a symbol may be the smallest scheduling unit (e.g., in the time domain) of the wireless communications system 100 and may be referred to as a transmission time interval (TTI). In some examples, the TTI duration (e.g., the number of symbol periods in a TTI) may be variable. Additionally or alternatively, the smallest scheduling unit of the wireless communications system 100 may be dynamically selected (e.g., in bursts of shortened TTIs (sTTIs)).

Physical channels may be multiplexed on a carrier according to various techniques. A physical control channel and a physical data channel may be multiplexed on a downlink carrier, for example, using one or more of time division multiplexing (TDM) techniques, frequency division multiplexing (FDM) techniques, or hybrid TDM-FDM techniques. A control region (e.g., a control resource set (CORESET)) for a physical control channel may be defined by a number of symbol periods and may extend across the system bandwidth or a subset of the system bandwidth of the carrier. One or more control regions (e.g., CORESETs) may be configured for a set of the UEs 115. For example, one or more of the UEs 115 may monitor or search control regions for control information according to one or more search space sets, and each search space set may include one or multiple control channel candidates in one or more aggregation levels arranged in a cascaded manner. An aggregation level for a control channel candidate may refer to a number of control channel resources (e.g., control channel elements (CCEs)) associated with encoded information for a control information format having a given payload size. Search space sets may include common search space sets configured for sending control information to multiple UEs 115 and UE-specific search space sets for sending control information to a specific UE 115.

Each base station 105 may provide communication coverage via one or more cells, for example a macro cell, a small cell, a hot spot, or other types of cells, or any combination thereof. The term “cell” may refer to a logical communication entity used for communication with a base station 105 (e.g., over a carrier) and may be associated with an identifier for distinguishing neighboring cells (e.g., a physical cell identifier (PCID), a virtual cell identifier (VCID), or others). In some examples, a cell may also refer to a geographic coverage area 110 or a portion of a geographic coverage area 110 (e.g., a sector) over which the logical communication entity operates. Such cells may range from smaller areas (e.g., a structure, a subset of structure) to larger areas depending on various factors such as the capabilities of the base station 105. For example, a cell may be or include a building, a subset of a building, or exterior spaces between or overlapping with geographic coverage areas 110, among other examples.

A macro cell generally covers a relatively large geographic area (e.g., several kilometers in radius) and may allow unrestricted access by the UEs 115 with service subscriptions with the network provider supporting the macro cell. A small cell may be associated with a lower-powered base station 105, as compared with a macro cell, and a small cell may operate in the same or different (e.g., licensed, unlicensed) frequency bands as macro cells. Small cells may provide unrestricted access to the UEs 115 with service subscriptions with the network provider or may provide restricted access to the UEs 115 having an association with the small cell (e.g., the UEs 115 in a closed subscriber group (CSG), the UEs 115 associated with users in a home or office). A base station 105 may support one or multiple cells and may also support communications over the one or more cells using one or multiple component carriers.

In some examples, a carrier may support multiple cells, and different cells may be configured according to different protocol types (e.g., MTC, narrowband IoT (NB-IoT), enhanced mobile broadband (eMBB)) that may provide access for different types of devices.

In some examples, a base station 105 may be movable and therefore provide communication coverage for a moving geographic coverage area 110. In some examples, different geographic coverage areas 110 associated with different technologies may overlap, but the different geographic coverage areas 110 may be supported by the same base station 105. In other examples, the overlapping geographic coverage areas 110 associated with different technologies may be supported by different base stations 105. The wireless communications system 100 may include, for example, a heterogeneous network in which different types of the base stations 105 provide coverage for various geographic coverage areas 110 using the same or different radio access technologies.

The wireless communications system 100 may support synchronous or asynchronous operation. For synchronous operation, the base stations 105 may have similar frame timings, and transmissions from different base stations 105 may be approximately aligned in time. For asynchronous operation, the base stations 105 may have different frame timings, and transmissions from different base stations 105 may, in some examples, not be aligned in time. The techniques described herein may be used for either synchronous or asynchronous operations.

Some UEs 115, such as MTC or IoT devices, may be low cost or low complexity devices and may provide for automated communication between machines (e.g., via Machine-to-Machine (M2M) communication). M2M communication or MTC may refer to data communication technologies that allow devices to communicate with one another or a base station 105 without human intervention. In some examples, M2M communication or MTC may include communications from devices that integrate sensors or meters to measure or capture information and relay such information to a central server or application program that makes use of the information or presents the information to humans interacting with the application program. Some UEs 115 may be designed to collect information or enable automated behavior of machines or other devices. Examples of applications for MTC devices include smart metering, inventory monitoring, water level monitoring, equipment monitoring, healthcare monitoring, wildlife monitoring, weather and geological event monitoring, fleet management and tracking, remote security sensing, physical access control, and transaction-based business charging.

Some UEs 115 may be configured to employ operating modes that reduce power consumption, such as half-duplex communications (e.g., a mode that supports one-way communication via transmission or reception, but not transmission and reception simultaneously). In some examples, half-duplex communications may be performed at a reduced peak rate. Other power conservation techniques for the UEs 115 include entering a power saving deep sleep mode when not engaging in active communications, operating over a limited bandwidth (e.g., according to narrowband communications), or a combination of these techniques. For example, some UEs 115 may be configured for operation using a narrowband protocol type that is associated with a defined portion or range (e.g., set of subcarriers or resource blocks (RBs)) within a carrier, within a guard-band of a carrier, or outside of a carrier.

The wireless communications system 100 may be configured to support ultra-reliable communications or low-latency communications, or various combinations thereof. For example, the wireless communications system 100 may be configured to support ultra-reliable low-latency communications (URLLC) or mission critical communications. The UEs 115 may be designed to support ultra-reliable, low-latency, or critical functions (e.g., mission critical functions). Ultra-reliable communications may include private communication or group communication and may be supported by one or more mission critical services such as mission critical push-to-talk (MCPTT), mission critical video (MCVideo), or mission critical data (MCData). Support for mission critical functions may include prioritization of services, and mission critical services may be used for public safety or general commercial applications. The terms ultra-reliable, low-latency, mission critical, and ultra-reliable low-latency may be used interchangeably herein.

In some examples, a UE 115 may also be able to communicate directly with other UEs 115 over a device-to-device (D2D) communication link 135 (e.g., using a peer-to-peer (P2P) or D2D protocol). One or more UEs 115 utilizing D2D communications may be within the geographic coverage area 110 of a base station 105. Other UEs 115 in such a group may be outside the geographic coverage area 110 of a base station 105 or be otherwise unable to receive transmissions from a base station 105. In some examples, groups of the UEs 115 communicating via D2D communications may utilize a one-to-many (1:M) system in which each UE 115 transmits to every other UE 115 in the group. In some examples, a base station 105 facilitates the scheduling of resources for D2D communications. In other cases, D2D communications are carried out between the UEs 115 without the involvement of a base station 105.

In some systems, the D2D communication link 135 may be an example of a communication channel, such as a sidelink communication channel, between vehicles (e.g., UEs 115). In some examples, vehicles may communicate using vehicle-to-everything (V2X) communications, vehicle-to-vehicle (V2V) communications, or some combination of these. A vehicle may signal information related to traffic conditions, signal scheduling, weather, safety, emergencies, or any other information relevant to a V2X system. In some examples, vehicles in a V2X system may communicate with roadside infrastructure, such as roadside units, or with the network via one or more network nodes (e.g., base stations 105) using vehicle-to-network (V2N) communications, or with both.

The core network 130 may provide user authentication, access authorization, tracking, Internet Protocol (IP) connectivity, and other access, routing, or mobility functions. The core network 130 may be an evolved packet core (EPC) or 5G core (5GC), which may include at least one control plane entity that manages access and mobility (e.g., a mobility management entity (MME), an access and mobility management function (AMF)) and at least one user plane entity that routes packets or interconnects to external networks (e.g., a serving gateway (S-GW), a Packet Data Network (PDN) gateway (P-GW), or a user plane function (UPF)). The control plane entity may manage non-access stratum (NAS) functions such as mobility, authentication, and bearer management for the UEs 115 served by the base stations 105 associated with the core network 130. User IP packets may be transferred through the user plane entity, which may provide IP address allocation as well as other functions. The user plane entity may be connected to the network operators IP services 150. The network operators IP services 150 may include access to the Internet, Intranet(s), an IP Multimedia Subsystem (IMS), or a Packet-Switched Streaming Service.

Some of the network devices, such as a base station 105, may include subcomponents such as an access network entity 140, which may be an example of an access node controller (ANC). Each access network entity 140 may communicate with the UEs 115 through one or more other access network transmission entities 145, which may be referred to as radio heads, smart radio heads, or transmission/reception points (TRPs). Each access network transmission entity 145 may include one or more antenna panels. In some configurations, various functions of each access network entity 140 or base station 105 may be distributed across various network devices (e.g., radio heads and ANCs) or consolidated into a single network device (e.g., a base station 105).

The wireless communications system 100 may operate using one or more frequency bands, typically in the range of 300 megahertz (MHz) to 300 gigahertz (GHz). Generally, the region from 300 MHz to 3 GHz is known as the ultra-high frequency (UHF) region or decimeter band because the wavelengths range from approximately one decimeter to one meter in length. The UHF waves may be blocked or redirected by buildings and environmental features, but the waves may penetrate structures sufficiently for a macro cell to provide service to the UEs 115 located indoors. The transmission of UHF waves may be associated with smaller antennas and shorter ranges (e.g., less than 100 kilometers) compared to transmission using the smaller frequencies and longer waves of the high frequency (HF) or very high frequency (VHF) portion of the spectrum below 300 MHz.

The wireless communications system 100 may also operate in a super high frequency (SHF) region using frequency bands from 3 GHz to 30 GHz, also known as the centimeter band, or in an extremely high frequency (EHF) region of the spectrum (e.g., from 30 GHz to 300 GHz), also known as the millimeter band. In some examples, the wireless communications system 100 may support millimeter wave (mmW) communications between the UEs 115 and the base stations 105, and EHF antennas of the respective devices may be smaller and more closely spaced than UHF antennas. In some examples, this may facilitate use of antenna arrays within a device. The propagation of EHF transmissions, however, may be subject to even greater atmospheric attenuation and shorter range than SHF or UHF transmissions. The techniques disclosed herein may be employed across transmissions that use one or more different frequency regions, and designated use of bands across these frequency regions may differ by country or regulating body.

The wireless communications system 100 may utilize both licensed and unlicensed radio frequency spectrum bands. For example, the wireless communications system 100 may employ License Assisted Access (LAA), LTE-Unlicensed (LTE-U) radio access technology, or NR technology in an unlicensed band such as the 5 GHz industrial, scientific, and medical (ISM) band. When operating in unlicensed radio frequency spectrum bands, devices such as the base stations 105 and the UEs 115 may employ carrier sensing for collision detection and avoidance. In some examples, operations in unlicensed bands may be based on a carrier aggregation configuration in conjunction with component carriers operating in a licensed band (e.g., LAA). Operations in unlicensed spectrum may include downlink transmissions, uplink transmissions, P2P transmissions, or D2D transmissions, among other examples.

A base station 105 or a UE 115 may be equipped with multiple antennas, which may be used to employ techniques such as transmit diversity, receive diversity, multiple-input multiple-output (MIMO) communications, or beamforming. The antennas of a base station 105 or a UE 115 may be located within one or more antenna arrays or antenna panels, which may support MIMO operations or transmit or receive beamforming. For example, one or more base station antennas or antenna arrays may be co-located at an antenna assembly, such as an antenna tower. In some examples, antennas or antenna arrays associated with a base station 105 may be located in diverse geographic locations. A base station 105 may have an antenna array with a number of rows and columns of antenna ports that the base station 105 may use to support beamforming of communications with a UE 115. Likewise, a UE 115 may have one or more antenna arrays that may support various MIMO or beamforming operations. Additionally or alternatively, an antenna panel may support radio frequency beamforming for a signal transmitted via an antenna port.

The base stations 105 or the UEs 115 may use MIMO communications to exploit multipath signal propagation and increase the spectral efficiency by transmitting or receiving multiple signals via different spatial layers. Such techniques may be referred to as spatial multiplexing. The multiple signals may, for example, be transmitted by the transmitting device via different antennas or different combinations of antennas. Likewise, the multiple signals may be received by the receiving device via different antennas or different combinations of antennas. Each of the multiple signals may be referred to as a separate spatial stream and may carry bits associated with the same data stream (e.g., the same codeword) or different data streams (e.g., different codewords). Different spatial layers may be associated with different antenna ports used for channel measurement and reporting. MIMO techniques include single-user MIMO (SU-MIMO), where multiple spatial layers are transmitted to the same receiving device, and multiple-user MIMO (MU-MIMO), where multiple spatial layers are transmitted to multiple devices.

Beamforming, which may also be referred to as spatial filtering, directional transmission, or directional reception, is a signal processing technique that may be used at a transmitting device or a receiving device (e.g., a base station 105, a UE 115) to shape or steer an antenna beam (e.g., a transmit beam, a receive beam) along a spatial path between the transmitting device and the receiving device. Beamforming may be achieved by combining the signals communicated via antenna elements of an antenna array such that some signals propagating at particular orientations with respect to an antenna array experience constructive interference while others experience destructive interference. The adjustment of signals communicated via the antenna elements may include a transmitting device or a receiving device applying amplitude offsets, phase offsets, or both to signals carried via the antenna elements associated with the device. The adjustments associated with each of the antenna elements may be defined by a beamforming weight set associated with a particular orientation (e.g., with respect to the antenna array of the transmitting device or receiving device, or with respect to some other orientation).

A base station 105 or a UE 115 may use beam sweeping techniques as part of beam forming operations. For example, a base station 105 may use multiple antennas or antenna arrays (e.g., antenna panels) to conduct beamforming operations for directional communications with a UE 115. Some signals (e.g., synchronization signals, reference signals, beam selection signals, or other control signals) may be transmitted by a base station 105 multiple times in different directions. For example, the base station 105 may transmit a signal according to different beamforming weight sets associated with different directions of transmission. Transmissions in different beam directions may be used to identify (e.g., by a transmitting device, such as a base station 105, or by a receiving device, such as a UE 115) a beam direction for later transmission or reception by the base station 105.

Some signals, such as data signals associated with a particular receiving device, may be transmitted by a base station 105 in a single beam direction (e.g., a direction associated with the receiving device, such as a UE 115). In some examples, the beam direction associated with transmissions along a single beam direction may be determined based on a signal that was transmitted in one or more beam directions. For example, a UE 115 may receive one or more of the signals transmitted by the base station 105 in different directions and may report to the base station 105 an indication of the signal that the UE 115 received with a highest signal quality or an otherwise acceptable signal quality.

In some examples, transmissions by a device (e.g., by a base station 105 or a UE 115) may be performed using multiple beam directions, and the device may use a combination of digital precoding or radio frequency beamforming to generate a combined beam for transmission (e.g., from a base station 105 to a UE 115). The UE 115 may report feedback that indicates precoding weights for one or more beam directions, and the feedback may correspond to a configured number of beams across a system bandwidth or one or more sub-bands. The base station 105 may transmit a reference signal (e.g., a cell-specific reference signal (CRS), a channel state information reference signal (CSI-RS)), which may be precoded or unprecoded. The UE 115 may provide feedback for beam selection, which may be a precoding matrix indicator (PMI) or codebook-based feedback (e.g., a multi-panel type codebook, a linear combination type codebook, a port selection type codebook). Although these techniques are described with reference to signals transmitted in one or more directions by a base station 105, a UE 115 may employ similar techniques for transmitting signals multiple times in different directions (e.g., for identifying a beam direction for subsequent transmission or reception by the UE 115) or for transmitting a signal in a single direction (e.g., for transmitting data to a receiving device).

A receiving device (e.g., a UE 115) may try multiple receive configurations (e.g., directional listening) when receiving various signals from the base station 105, such as synchronization signals, reference signals, beam selection signals, or other control signals. For example, a receiving device may try multiple receive directions by receiving via different antenna subarrays, by processing received signals according to different antenna subarrays, by receiving according to different receive beamforming weight sets (e.g., different directional listening weight sets) applied to signals received at multiple antenna elements of an antenna array, or by processing received signals according to different receive beamforming weight sets applied to signals received at multiple antenna elements of an antenna array, any of which may be referred to as “listening” according to different receive configurations or receive directions. In some examples, a receiving device may use a single receive configuration to receive along a single beam direction (e.g., when receiving a data signal). The single receive configuration may be aligned in a beam direction determined based on listening according to different receive configuration directions (e.g., a beam direction determined to have a highest signal strength, highest signal-to-noise ratio (SNR), or otherwise acceptable signal quality based on listening according to multiple beam directions).

The wireless communications system 100 may be a packet-based network that operates according to a layered protocol stack. In the user plane, communications at the bearer or Packet Data Convergence Protocol (PDCP) layer may be IP-based. A Radio Link Control (RLC) layer may perform packet segmentation and reassembly to communicate over logical channels. A Medium Access Control (MAC) layer may perform priority handling and multiplexing of logical channels into transport channels. The MAC layer may also use error detection techniques, error correction techniques, or both to support retransmissions at the MAC layer to improve link efficiency. In the control plane, the Radio Resource Control (RRC) protocol layer may provide establishment, configuration, and maintenance of an RRC connection between a UE 115 and a base station 105 or a core network 130 supporting radio bearers for user plane data. At the physical layer, transport channels may be mapped to physical channels.

The UEs 115 and the base stations 105 may support retransmissions of data to increase the likelihood that data is received successfully. Hybrid automatic repeat request (HARQ) feedback is one technique for increasing the likelihood that data is received correctly over a communication link 125. HARQ may include a combination of error detection (e.g., using a cyclic redundancy check (CRC)), forward error correction (FEC), and retransmission (e.g., automatic repeat request (ARQ)). HARQ may improve throughput at the MAC layer in poor radio conditions (e.g., low signal-to-noise conditions). In some examples, a device may support same-slot HARQ feedback, where the device may provide HARQ feedback in a specific slot for data received in a previous symbol in the slot. In other cases, the device may provide HARQ feedback in a subsequent slot, or according to some other time interval.

Sidelink communications may support communications within a group of UEs. For example, sidelink communications may include communications between a UE and other UEs within a coverage area including the group of UEs (e.g., a coverage area provided by a base station, a coverage area outside of the coverage area provided by the base station, or a combination thereof). One or more of the UEs in the group of UEs may initiate sidelink communications with other UEs in the group of UEs. In some examples, base stations may not be involved in sidelink communications because multiple UEs on the sidelink may receive a data transmission from a single UE, or a single UE may receive data transmissions from multiple UEs.

In some examples, V2X communication may support two resource allocation mechanisms. In one mechanism, resources may be scheduled by a base station, and in another mechanism, a UE may perform autonomous resource selection. In wireless communications systems supporting sidelink communications, inter-UE coordination may be improved to increase reliability and efficiency. In case of mode 2 operation, a transmitting UE may perform a sensing operation to find occupied and/or available resources to utilize for an upcoming transmission. In some wireless communications systems, wireless devices, such as UEs, may include multiple TRPs. For example, some vehicles may include TRPs at the front and rear of the vehicle such that the TRPs are separated by a distance in the range of 2-20 meters, depending on the length of the vehicle. In some cases, the respective TRPs may include different quantities of other wireless devices to which they are connected (e.g., more traffic in front of a vehicle may cause a front TRP to have a higher quantity of wireless connections than a rear TRP). A transmitter UE may utilize a sidelink control information associated with a first TRP to reserve resources for a second TRP.

According to one or more aspects of the present disclosure, a receiver UE 115 may receive a sidelink control information associated with a first TCI state over a sidelink channel. The receiver UE 115 may determine that the sidelink control information has reserved resources for a second TCI state. In some examples, the second TCI state may be different from the first TCI state. The receiver UE 115 may then selectively enable or disable resource protection for the reserved resources for the second TCI state based on a signal strength associated with the first TCI state or the second TCI state, a network congestion parameter, a data priority associated with the sidelink data transmission, or a combination thereof.

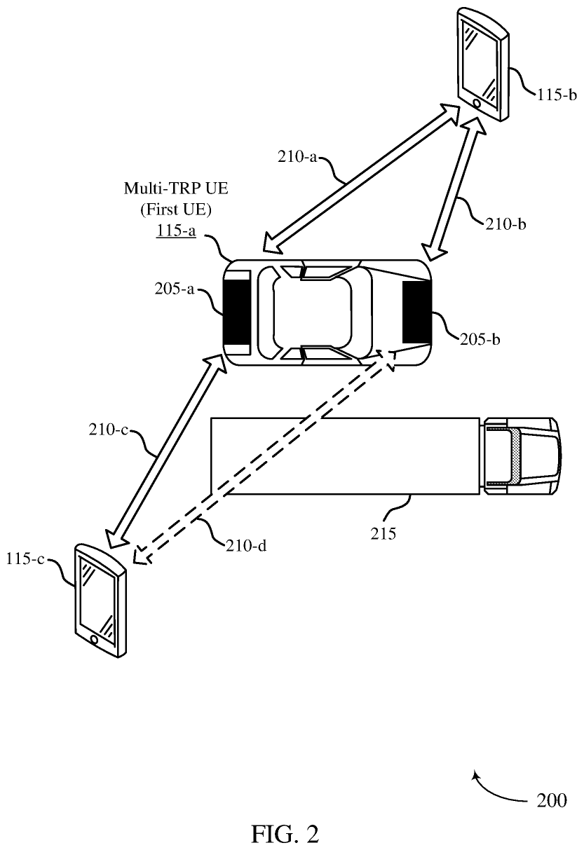

FIG. 2 illustrates an example of a wireless communications system 200 that supports techniques for sidelink resource exclusion with a multi-TRP enabled transmitter in accordance with aspects of the present disclosure. In some examples, the wireless communications system 200 may implement aspects of wireless communications system 100. The wireless communications system 200 may include a first UE 115-a, a second UE 115-b, and a third UE 115-c, which may be examples of UEs 115 described with reference to FIG. 1.

The wireless communications system 200 may include the one or more UEs 115 (may also be referred to as devices) in a geographic coverage area (not shown). In some cases, the wireless communications system 200 may utilize control signaling to schedule resources for UEs 115 to perform sidelink communications. Additionally or alternatively, the UEs 115 in the wireless communications system 200 may utilize shared information to enhance scheduling, inter-UE coordination, and communications flexibility. In some examples, the group of UEs 115 (e.g., UE 115-a (UE 1), UE 115-b (UE 2), and UE 115-c (UE 3)) may communicate with each other (e.g., within a V2X system, a D2D system, and the like) and may employ sidelink transmissions to save power, reduce latency, and ensure reliable communications. In some examples, vehicles may communicate using V2X resource allocation mode 2 (that utilizes UE autonomous resource selection).

Although not depicted in the example of FIG. 2, it may be understood that the wireless communications system 200 may support both access links and sidelinks for communications between one or more communication devices. An access link may refer to a communication link between a UE 115 (such as, UE 115-a and UE 115-b) and a base station. A sidelink may refer to any communication link between similar wireless devices (e.g., a communication link between UEs, or a backhaul communication link between base stations). It is noted that while various examples provided herein are discussed for UE sidelink devices, such sidelink techniques may be used for any type of wireless devices that use sidelink communications. For example, a sidelink may support one or more of D2D communications, V2X or V2V communications, message relaying, discovery signaling, beacon signaling, or other signals transmitted over-the-air from one UE to one or more other UEs.

In some aspects, a first UE 115-a (UE 1) illustrated in FIG. 2 may include a multi-TRP UE 115-a. For example, the first UE 115-a may include a first TRP 205-a and a second TRP 205-b. In some aspects, each of the TRPs 205-a and 205-b may be configured to receive and transmit signals. The TRPs 205-a and 205-b may be configured to transmit signals in conjunction with one another, individually (e.g., separately from one another), or both. In this regard, the TRPs 205 may include, but are not limited to, antennas, antenna panels, and the like. In some examples, a device supporting sidelink communications (e.g., a car) may include a front antenna panel and a rear antenna panel. Subsequently, larger vehicles (such as trucks and trailers) may include multiple TRPs.

In some cases, the TRPs 205 of the first UE 115-a may be positioned proximate (e.g., close) to one another. In other cases, the TRPs 205 of the first UE 115-a may be physically separated from each other by some distance. For example, in the context of a vehicle, the first TRP 205-a may be positioned near the front of the vehicle, and the second TRP 205-b may be positioned at near the rear of the vehicle. In this example, the first TRP 205-a (e.g., first antenna panel) and the second TRP 205-b (e.g., second antenna panel) may be separated from one another by several meters. This physical separation may be even larger in the case of larger UEs 115, such as semi-trucks, where multiple TRPs 205 may be physically separated from one another by twenty meters or more.

Due to the separate components, physical position, and physical separation between the first TRP 205-a and the second TRP 205-b, each of the respective TRPs 205 may view the channel differently. For example, the first TRP 205-a may receive signals from the second UE 115-b via a communications link 210-a, and the second TRP 205-b may receive signals from the second UE 115-b via communications link 210-b. In this example, the signals received at the first TRP 205-a may travel a greater distance than the signals received at the second TRP 205-b. The varying propagation distances may result in varying parameters (e.g., characteristics) associated with the signals received by the respective TRPs 205. For instance, due to the differences in propagation distances, the signals received at the first TRP 205-a may exhibit a lower signal quality (e.g., lower reference signal received power, lower reference signal received quality, higher signal to noise ratio, higher signal to interference plus noise ratio) as compared to the signals received at the second TRP 205-b. Moreover, the signals received at the first TRP 205-a may be received later in time than the signals received at the second TRP 205-b. These differences in signal parameters (e.g., reference signal received power, reference signal received quality, signal to noise ratio, signal to interference plus noise ratio, time of receipt) may result despite the fact that the respective signals were transmitted by the second UE 115-b at the same time and with the same transmit power.

Physical obstructions, weather conditions, noise, line of sight (LoS) vs. non-line of sight (NLoS), and other conditions may further increase differences between signals transmitted and/or received by the respective TRPs 205. For example, the third UE 115-c may transmit signals to or receive signals from the first TRP 205-a via a communications link 210-c, and may transmit signals to or receive signals from the second TRP 205-b b via a communications link 210-d. In this example, the signals may be effectively transmitted from or received by the first TRP 205-a. However, the signals transmitted from or received by the second TRP 205-b may be deflected, blocked, or otherwise interfered with by an obstruction 215, such as a truck. In this example, the signals may not be received from the third UE 115-c at the second TRP 205-b due to the obstruction 215. Additionally or alternatively, signals which are received at the second TRP 205-b may suffer from low signal quality as compared to the signals received by the first TRP 205-a.

Each TRP in a UE may have different number of peers and/or different links to each peer. In some examples, traffic load may be higher for one TRP than another (e.g. there may be more cars in front than behind a vehicle). In some examples, the second TRP 205-b may have poor link connections than the first TRP 205-a. These differences in channel qualities and/or signal qualities perceived by the respective TRPs 205 may result in issues experienced by the multi-TRP UE 115-a which are not experienced by other UEs 115 (e.g., single-TRP UEs 115). In such cases, it may be beneficial for the UE (e.g., UE 115-a) to transmit with more power, or lower modulation and coding scheme from one TRP (e.g., the TRP perceiving a higher signal quality).

In some cases, a multi-TRP UE may send transmissions of the same packet from different TRPs. Each transmission may be associated with one or more TCI states. In some examples, a multi-TRP UE may reserve transmission resources for future transmissions by signaling a sidelink control information. For example, the first TRP 205-a in the first UE 115-a may transmit a sidelink control information to reserve resources for a future transmission. In some examples, to account for the differences in channel/signal qualities, the first TRP 205-a may reserve resources for the second TRP 205-b (as the signal quality perceived at the second TRP 205-b may be lower than the first TRP 205-a). In some wireless communications systems, upon receiving the sidelink control information which schedules sidelink transmissions, UEs may assume that the sidelink transmission have the same TCI state. That is, a receiver UE (e.g., UE 115-b and/or UE 115-a) may assume that all reserved transmission resources are for a particular TRP.

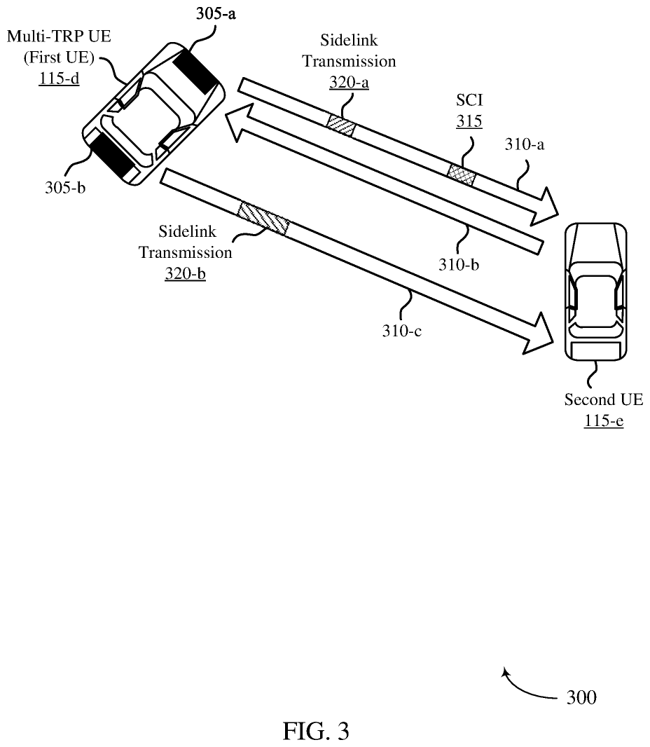

In the absence of TCI indicating the respective TRPs, some techniques do not enable multi-TRP UEs to reserve resources for future transmission for multiple TRPs. In this regard, techniques for transmission and reception of sidelink transmission with a multi-TRP UEs 115 are described. One or more aspects of the present disclosure provides for a multi-TRP UE 115-a d to use sidelink control information associated with a first TCI state (e.g., TCI-0) to reserve resources for a second TCI state (e.g., TCI-1). That is, the multi-TRP UE 115-a may use SCI associated with a first TRP (e.g., first TRP 205-a) to reserve resources for a second TRP (e.g., second TRP 205-b). A receiver UE (e.g., UE 115-b, UE 115-c) may receive the sidelink control information associated with TCI-0 and may determine that the sidelink control information has reserved resources for TCI-1. The receiver UE may then enable or disable resource protection for the reserved resources for TCI-1 based on a number of parameters. According to one or more aspects, the receiver UE may enable or disable resource protection for the reserved resources for TCI-1 based on signal strength associated with the first TCI state or the second TCI state, a network congestion parameter, or a data priority associated with the sidelink data transmission. Attendant advantages of the techniques described herein may be further shown and described with reference to FIG. 3.

FIG. 3 illustrates an example of a wireless communications system 300 that supports techniques for sidelink resource exclusion with a multi-TRP enabled transmitter in accordance with aspects of the present disclosure. In some examples, the wireless communications system 300 may implement aspects of the wireless communications system 100 or the wireless communications system 200. The wireless communications system 300 may include a first UE 115-d and a second UE 115-e, which may be examples of UEs 115 described with reference to FIGS. 1 and 2.

In some aspects, the first UE 115 d may include a multi-TRP UE 115-d, as described previously herein with reference to FIGS. 1 and 2. In this regard, the first UE 115-d may include a first TRP 305-a and a second TRP 305-b different from the first TRP 305-a. The TRPs 305-a and 305-b may be configured to transmit signals in conjunction with one another, individually (e.g., separately from one another), or both. In this regard, the TRPs 305 may include, but are not limited to, antennas, antenna panels, and the like.

The UEs 115 of the wireless communications system 300 may communicate with one another via communications links. For example, the first UE 115-d may communicate with the second UE 115-e via a communications links 310 (e.g., 310-a and 310-b). Although not depicted in the example of FIG. 3, the first UE 115-d (e.g., multi-TRP UE) may also communicate with additional UEs via additional communications links. The communications links 310-a, 310-b, and 310-c may be examples of sidelink communication links (e.g., PC5 links). In this regard, the communications links may include bi-directional links between the respective UEs 115-d and 115-e. In some aspects, each of the respective TRPs 305 may communicate with other wireless devices (e.g., second UE) within the wireless communications system 300 via separate communications links. For example, the first TRP 305-a of the first UE 115-d may transmit signals to the second UE 115-e via the communications link 310-a. Similarly, the second TRP 305-b of the first UE 115 d may transmit signals to the second UE 115-e via the communications link 310-c. In some examples, the first TRP 305-a of the first UE 115-d may receive signals from the second UE 115-e via the communications link 310-b. In some aspects, the second UE 115-e may additionally communicate with other UEs via one or more communications links (e.g., sidelink communication links, PC5 links).

As depicted herein, the UEs 115 of the wireless communications system 300 may support techniques for directional sidelink transmission with a multi-TRP UE. In particular, the UEs 115 of the wireless communications system may be configured to perform sidelink transmissions with a first TRP, where the first TRP reserves resources for upcoming transmissions from a second TRP. A multi-TRP UE (e.g., first UE 115-d) may reserve transmission resources for future transmissions by signaling a sidelink control information associated with a first TCI state. That is, a multi-TRP UE may be configured to use sidelink control information associated with a first TCI state (e.g., TCI-0) to reserve resources for a second TCI state (e.g., TCI-1). By performing such resource reservations, the multi-TRP UE may be able to provide greater protection to sidelink transmissions by transmitting sidelink transmissions with the respective TRPs with varying quantities of retransmissions and varying sets of parameters, thereby improving the efficiency and reliability of sidelink communications.

According to one or more aspects of the present disclosure, a multi-TRP UE 115-d may configure a sidelink control information transmission associated with a first TCI state to reserve time and frequency resources for a sidelink data transmission associated with a second TCI state. In some examples, the sidelink control information transmission may also reserve resources for sidelink transmission 320-a. In some examples, the sidelink control information transmission may include an indication of the second TCI state. In the example of FIG. 3, the multi-TRP UE 115 may configure the sidelink control information to include an indication of the second TCI state associated with the second TRP 305-b. That is, to protect sidelink transmissions, the multi-TRP UE 115-d may include an indication of the TCI-1 (associated with second TRP 305-b) in the sidelink control information 315 associated with TCI-0 (associated with first TRP 305-a). The transmitter UE (or multi-TRP UE 115-d) may include one or more sidelink control information to reserve resources for future retransmissions along with the sidelink control information 315 for a current packet (to be used by a receiver to decode the packet). In some examples, when reserving retransmissions for multiple TRPs, the multi-TRP UE 115-d may indicate TCI-state identifier in the sidelink control information 315. For example, the TCI state identifier in the sidelink control information 315 may indicate that the sidelink control information 315 is reserving resources for a different TRP (e.g., second TRP 305-b). The multi-TRP UE 115-d may identify a TCI state identifier associated with the second TCI state (or TCI 1 associated with the second TRP 305-b). The multi-TRP UE 115-d may then include the TCI state identifier in the sidelink control information 315 associated with the first TCI state (or TCI 0 associated with the first TRP 305-a). In another example, the multi-TRP UE 115-d may set a bit in the sidelink control information 315 to indicate that the future reservation is for a different TRP. For example, the multi-TRP UE 115-d may include a single bit in the sidelink control information 315 associated with the first TCI state (or the first TRP 305-a). A value of the bit may include an indication of reservation of the time and frequency resources for the sidelink data transmission associated with the second TCI state (or TCI 1 associated with the second TRP 305-b). In some cases, the multi-TRP UE 115-d may set the bit to one if the future reservation is for the same TCI-state. Additionally or alternatively, the bit may be unset (or set to zero) if the future reservation is for a different TCI-state or vice versa. That is, absence of this bit in the SCI may imply that the reservations are for the same or quasi co-located TRPs. The multi-TRP UE 115-d may then transmit the sidelink control information 315 associated with the first TRP 305-a reserving future resources for the second TRP 305-b.

According to one or more aspects, a receiver UE (or second UE 115-e) may receive the sidelink control information 315 associated with a first TCI state (from the first TRP 305-a) over a sidelink channel. The second UE 115-e may determine that the sidelink control information 315 reserves time and frequency resources for a sidelink data transmission (e.g., sidelink transmission 320-b) associated with a second TCI state (associated with the second TRP 305-b). As depicted herein, the second TCI state may be different from the first TCI state. After receiving the sidelink control information 315 associated with TCI-0 and determining that the sidelink control information 315 has reserved resources for TCI-1, the second UE 115-e may selectively enable or disable resource protection for the reserved resources for TCI-1 based on a number of parameters. The parameters may include signal strength associated with the first TCI state or the second TCI state, a network congestion parameter, or a data priority associated with the sidelink data transmission.

In some examples, the second UE 115-e may assume that TCI-1 is un-reachable and may not apply any protection to the reserved resources. Additionally or alternatively, the second UE 115-e may apply protection (e.g., maximum protection) to resources reserved for TCI-1 (e.g. the second UE 115-e may enable a reservation threshold of 0 dBm for the reserved resources). By way of another example, the second UE 115-e may apply a reference signal received power measured on sidelink control information 315 for protecting the reserved resources (for second TRP 305-b). Additionally or alternatively, the second UE 115-e may estimate a protection value based on past data or direction of the sidelink control information 315.

The second UE 115-e may determine to disable resource protection for the reserved resources for TCI-1 in loaded networks or when reference signal received power on the reserves resources is high (e.g., greater than a threshold). In one example, the second UE 115-e may identify the signal strength associated with the second TCI state (for the second TRP 305-b). The signal strength may include a reference signal received power associated with the reserved time and frequency resources for the second TRP 305-b. The second UE 115-e may also determine that the reference signal received power satisfies a threshold. In such cases, the second UE 115-e may disable the resource protection procedure for the reserved time and frequency resources on determining that the reference signal received power is greater than the threshold. Additionally or alternatively, the second UE 115-e may determine that the network congestion parameter associated with the sidelink channel satisfies a threshold (e.g., the network is loaded). In such a case, the second UE 115-e may disable the resource protection procedure for the reserved time and frequency resources.

In some examples, the second UE 115-e may determine to protect the reserved resources (e.g., resources reserved for the second TRP 305-b) with a maximum reference signal received power limit. The second UE 115-e may identify a reference signal received power threshold associated with the reserved time and frequency resources and may enable the resource protection procedure for the reserved time and frequency resources based on the reference signal received power threshold. In some cases, the reference signal received power threshold may include a maximum reference signal received power limit supported by the second UE 115-e. In some examples, the second UE 115-e may enable resource protection for the reserved resources for TCI-1 (associated with the second TRP 305-b) using the same reference signal received power as measured over the sidelink control information 315 associated with TCI-0 (associated with the first TRP 305-a). To enable resource protection, the second UE 115-e may perform one or more measurements on the sidelink control information 315 associated with the first TRP 305-a. The one or more measurements may include a reference signal received power measurement for the first TCI state (TCI-0 associated with the first TRP 305-a).

By way of another example, the second UE 115-e may enable resource protection for the reserved resources for TCI-1 (e.g., for sidelink transmission 320-b from the second TRP 305-b) using an estimated reference signal received power value (e.g., reference signal received power offset value calculated based on past transmissions). For instance, the second UE 115-e may determine that the first TCI state (or TCI-0) is associated with the first TRP 305-a and the second TCI state (or TCI-1) is associated with the second TRP 305-b. The second UE 115-e may determine a reference signal received power offset between the first TRP and the second TRP based on one or more prior transmissions received from the first TRP 305-a or the second TRP 305-b or both. In some examples, the one or more prior transmissions may be received within a threshold time period (within past N slots) prior to receiving the sidelink control information 315 associated with the first TCI state.

In one example, the second UE 115-e may compute that the TRP-1 and TRP-0 have a reference signal received power difference and the second UE 115-e may use this different to protect the resources being reserved for TRP-1 by TRP-0. For instance, the second UE 115-e may perform a reference signal received power measurement on the sidelink control information 315 associated with the first TCI state (TCI-0 associated with the first TRP 305-a). The second UE 115-e may adjust the reference signal received power measurement based on a reference signal received power offset value calculated based on past transmissions. In some examples, the resource protection procedure may be based on the adjusted reference signal received power measurement.

For unicast transmissions, the second UE 115-e may use prior reference signal received power offset values if a current transmission is for the same destination identifier as a past unicast transmission. For example, the second UE 115-e may determine whether a destination identifier for the sidelink control information 315 is same as a destination identifier for the one or more prior transmissions. The second UE 115-e may further determine a reference signal received power offset based on the destination identifier for the sidelink control information transmission being the same as the destination identifier for the one or more prior transmissions. The one or more prior transmissions may include at least one of broadcast transmissions, multicast transmissions, unicast transmissions, or a combination thereof. That is, the second UE 115-e receiving a unicast transmission may use reference signal received power offset or reference signal received power estimates from past broadcast or multicast transmissions.

In some examples, the second UE 115-e may use a current reference signal received power to determine a future reference signal received power value. For instance, if a current sidelink control information (e.g., sidelink control information 315) has a low reference signal received power, the second UE 115-e may choose to protect the future reservation from another TCI state (e.g., TCI-1) with a higher reference signal received power (as the second TRP 305-b may be closer or have access with higher quality channel). The second UE 115-e may perform a reference signal received power measurement on the sidelink control information 315. In some cases, the second UE 115-e may determine a threshold for the resource protection procedure for an upcoming reservation of time and frequency resources associated with the second TCI state (e.g., TCI-1) based on the reference signal received power measurement on the sidelink control information 315 (associated with TCI-0). As described herein, the threshold may include a second reference signal received power greater than the measured reference signal received power.

By way of another example, the second UE 115-e may choose to enable or disable the resource protection procedure based on a data priority associated with sidelink data transmission at the second UE 115-e (e.g., traffic at the second UE 115-e). In some examples, the second UE 115-e may identify a data priority associated with the sidelink data transmission and may enable the resource protection procedure for the reserved time and frequency resources based on the identified data priority. Additionally or alternatively, the second UE 115-e may identify a data priority associated with the sidelink data transmission and may disable the resource protection procedure for the reserved time and frequency resources based on the identified data priority. For example, the second UE 115-e may disable protection for low priority traffic and enable protection for high priority traffic.

According to one or more aspects, if transmission reserving the future resources fails, the second UE 115-e may determine that a higher protection is needed for future transmissions. In such cases, the second UE 115-e may update resource protection of reserved resources with a higher value of reference signal received power (e.g., maximum reference signal received power). For example, the second UE 115-e may determine that reception of the sidelink transmission 320-b (e.g., sidelink data transmission) associated with the second TCI state is unsuccessful. In such cases, the second UE 115-e may determine a threshold for the resource protection procedure for an upcoming reservation of time and frequency resources associated with the second TCI state based on the unsuccessful reception of the sidelink transmission 320-b. In some examples, the threshold for the resource protection procedure for the upcoming reservation of time and frequency resources may be greater than a threshold for the resource protection procedure for the reserved time and frequency resources for the second TRP 305-b. Additionally or alternatively, the second UE 115-e may successfully receive the sidelink transmission 320-b associated with the second TCI state (or TCI-1). The second UE 115-e may then determine a threshold for the resource protection procedure for an upcoming reservation of time and frequency resources associated with the second TCI state based on the successful reception of the sidelink data transmission. That is, the second UE 115-e may choose to use the reference signal received power measured on the current transmission to protect future transmissions for a particular TCI state upon successful reception of the packets from that TRP (e.g., for which the estimated protection was applied by the second UE 115-e).

In some examples, the second UE 115-e may disable the resource protection procedure for the reserved time and frequency resources and may communicate over the reserved time and frequency resources based on disabling the resource protection procedure. For example, the second UE 115-e may choose to communicate over the reserved time and frequency resources in a loaded network. In such cases, the second UE 115-e may apply additional protection for the resources reserved for future transmission from that particular TCI state (e.g., second TRP 305-b in the example of FIG. 3).

Techniques described herein may enable the first UE 115-d (e.g., multi-TRP UE 115-d) to use a sidelink control information for a first TCI state to reserve resources for a second TCI state. The receiver UE may selectively enable or disable resource protection for the reserved resources and may effectively protect future resources for the second TCI state based on receiving the sidelink control information associated with the first TCI state. Moreover, by selectively enabling or disabling resource protection, techniques described herein may reduce signaling overhead within the wireless communications system 300, and may reduce power consumption at the multi-TRP UE 115-d and the second UE 115-e, thereby improving battery performance and improving user experience.

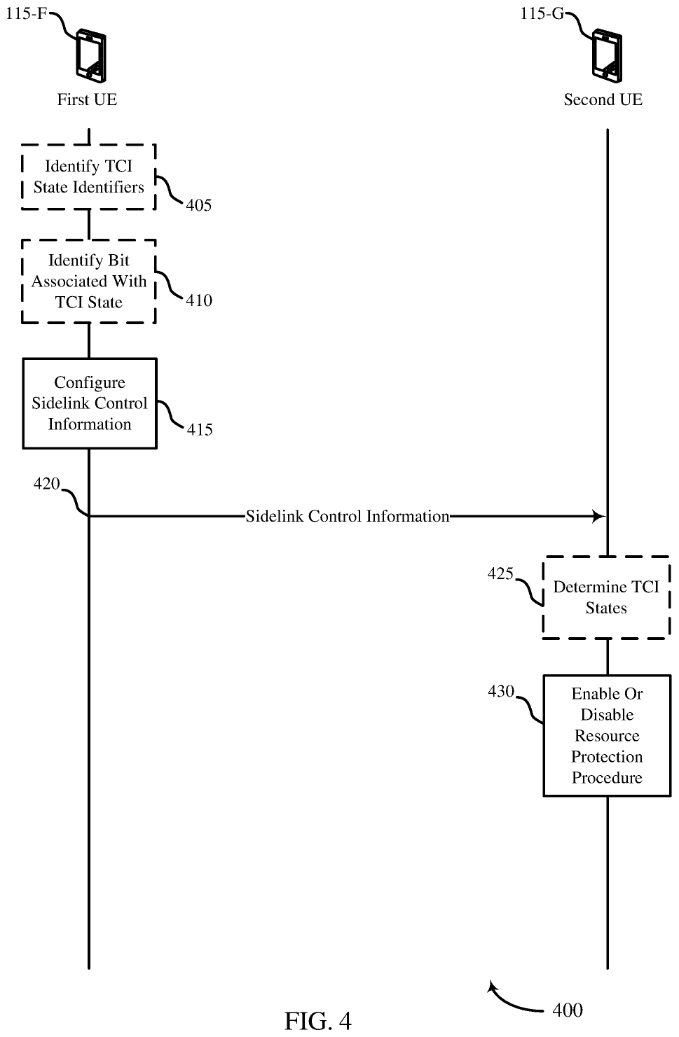

FIG. 4 illustrates an example of a process flow 400 that supports techniques for sidelink resource exclusion with a multi-TRP enabled transmitter in accordance with aspects of the present disclosure. In some examples, the process flow 400 may implement aspects of wireless communications system 100, 200, 300, or any combination thereof. For example, the process flow 400 may illustrate a first UE 115-f transmitting a sidelink control information associated with a first TRP reserving resources for a second TRP, as described with reference to FIGS. 1-3.

In some cases, process flow 400 may include a first UE 115-f and a second UE 115-g, which may be examples of corresponding devices as described herein. The first UE 115-f and a second UE 115-g illustrated in FIG. 4 may be examples of the first UE 115-d and the second UE 115-e respectively, illustrated in FIG. 3. In this regard, the first UE 115-f may include a multi-TRP UE 115. In some aspects, the respective UEs 115 illustrated in FIG. 4 may communicate with one another via sidelink communications links, such as the communications links 310-a, 310-b and 310-c illustrated in FIG. 3.

In some examples, the operations illustrated in process flow 400 may be performed by hardware (e.g., including circuitry, processing blocks, logic components, and other components), code (e.g., software or firmware) executed by a processor, or any combination thereof. Alternative examples of the following may be implemented, where some steps are performed in a different order than described or are not performed at all. In some cases, steps may include additional features not mentioned below, or further steps may be added.

At 405, the first UE 115-f may determine to use sidelink control information associated with a first TCI state (e.g., associated with a first TRP) to reserved resources for a second TCI state (e.g., associated with a second TRP). In such cases, the UE 115-f may optionally identify a TCI state identifier associated with the second TCI state.

At 410, the first UE 115-f may optionally identify a bit in a sidelink control information transmission associated with the first TCI state. In some examples, a value of the bit may include an indication of reservation of the time and frequency resources for the sidelink data transmission associated with the second TCI state.

At 415, the first UE 115-f may configure a sidelink control information transmission associated with a first TCI state to reserve time and frequency resources for a sidelink data transmission associated with a second TCI state. As depicted herein, the sidelink control information transmission may include an indication of the second TCI state. For example, the first UE 115-f may include the TCI state identifier (identified at 405) in the sidelink control information transmission associated with the first TCI state. Additionally or alternatively, the first UE 115-f may include the bit (identified at 410) in the sidelink control information transmission associated with the first TCI state.

At 420, the first UE 115-f may transmit, to the second UE 115-g, the sidelink control information transmission associated with the first TCI state over a sidelink channel. The second UE 115-g may receive the sidelink control information transmission associated with the first TCI state over the sidelink channel.

At 425, the second UE 115-g may determine that the sidelink control information transmission reserves time and frequency resources for a sidelink data transmission associated with a second TCI state. The second UE 115-g may also determine that the second TCI state is different from the first TCI state. In some examples, the second UE 115-g may determine that the first TCI state is associated with a first TRP at the first UE 115-f and the second TCI state is associated with a second TRP at the first UE 115-f.

At 430, the second UE 115-g may selectively enable or disable a resource protection procedure for the reserved time and frequency resources based on the determination and one or more parameters. In some examples, the one or more parameters may include a signal strength associated with the first TCI state or the second TCI state, a network congestion parameter, or a data priority associated with the sidelink data transmission.

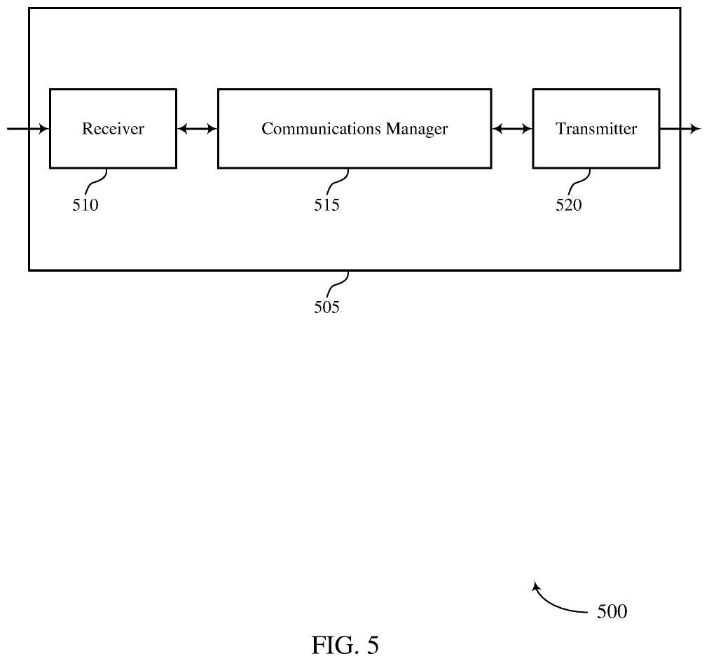

FIG. 5 shows a block diagram 500 of a device 505 that supports techniques for sidelink resource exclusion with a multi-TRP enabled transmitter in accordance with aspects of the present disclosure. The device 505 may be an example of aspects of a UE 115 as described herein. The device 505 may include a receiver 510, a communications manager 515, and a transmitter 520. The device 505 may also include a processor. Each of these components may be in communication with one another (e.g., via one or more buses).

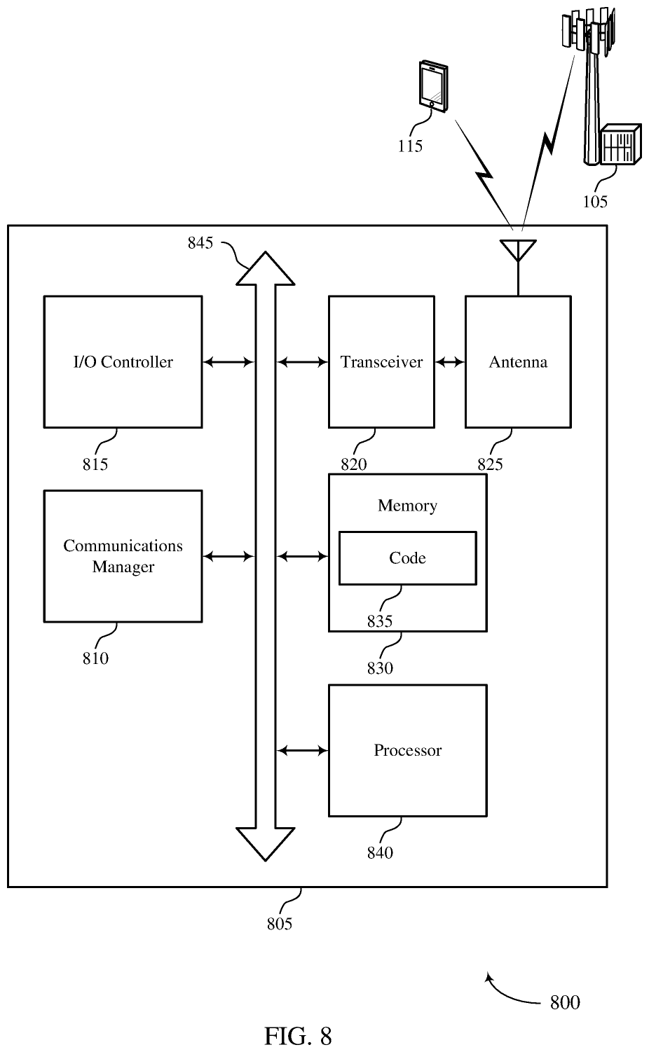

The receiver 510 may receive information such as packets, user data, or control information associated with various information channels (e.g., control channels, data channels, and information related to techniques for sidelink resource exclusion with a multi-TRP enabled transmitter, etc.). Information may be passed on to other components of the device 505. The receiver 510 may be an example of aspects of the transceiver 820 described with reference to FIG. 8. The receiver 510 may utilize a single antenna or a set of antennas.

The communications manager 515 may receive, from a second UE a sidelink control information transmission associated with a first TCI state over a sidelink channel, determine that the sidelink control information transmission reserves time and frequency resources for a sidelink data transmission associated with a second TCI state, the second TCI state being different from the first TCI state, and selectively enable or disabling a resource protection procedure for the reserved time and frequency resources based on the determination and one or more of: a signal strength associated with the first TCI state or the second TCI state, a network congestion parameter, or a data priority associated with the sidelink data transmission.

The communications manager 515 may also configure a sidelink control information transmission associated with a first TCI state to reserve time and frequency resources for a sidelink data transmission associated with a second TCI state, the sidelink control information transmission including an indication of the second TCI state and transmit, to a second UE the sidelink control information transmission associated with the first TCI state over a sidelink channel. The communications manager 515 may be an example of aspects of the communications manager 810 described herein.

The communications manager 515, or its sub-components, may be implemented in hardware, code (e.g., software or firmware) executed by a processor, or any combination thereof. If implemented in code executed by a processor, the functions of the communications manager 515, or its sub-components may be executed by a general-purpose processor, a DSP, an application-specific integrated circuit (ASIC), a field programmable gate array (FPGA) or other programmable logic device, discrete gate or transistor logic, discrete hardware components, or any combination thereof designed to perform the functions described in the present disclosure.

The communications manager 515, or its sub-components, may be physically located at various positions, including being distributed such that portions of functions are implemented at different physical locations by one or more physical components. In some examples, the communications manager 515, or its sub-components, may be a separate and distinct component in accordance with various aspects of the present disclosure. In some examples, the communications manager 515, or its sub-components, may be combined with one or more other hardware components, including but not limited to an input/output (I/O) component, a transceiver, a network server, another computing device, one or more other components described in the present disclosure, or a combination thereof in accordance with various aspects of the present disclosure.

The transmitter 520 may transmit signals generated by other components of the device 505. In some examples, the transmitter 520 may be collocated with a receiver 510 in a transceiver module. For example, the transmitter 520 may be an example of aspects of the transceiver 820 described with reference to FIG. 8. The transmitter 520 may utilize a single antenna or a set of antennas.

Based on performing enhanced sidelink communications, a processor of the multi-TRP UE 115 (e.g., a processor controlling the receiver 510, the communication manager 515, the transmitter 520, etc.) may reduce processing resources used for wireless communications. For example, by enabling resource reservation for a second TRP to be performed by a first TRP, a quantity of sidelink transmissions and retransmissions may be reduced, thereby reducing network overhead and improving efficiency. Moreover, by enabling efficient resource exclusion at a receiver UE 115, techniques described herein may reduce how often a processor of the multi-TRP UE 115 must ramp up to handle signal transmission or retransmission and reception, thereby reducing processing resources at the multi-TRP UE 115 and the receiver UE 115, reducing power consumption, and improving battery performance.

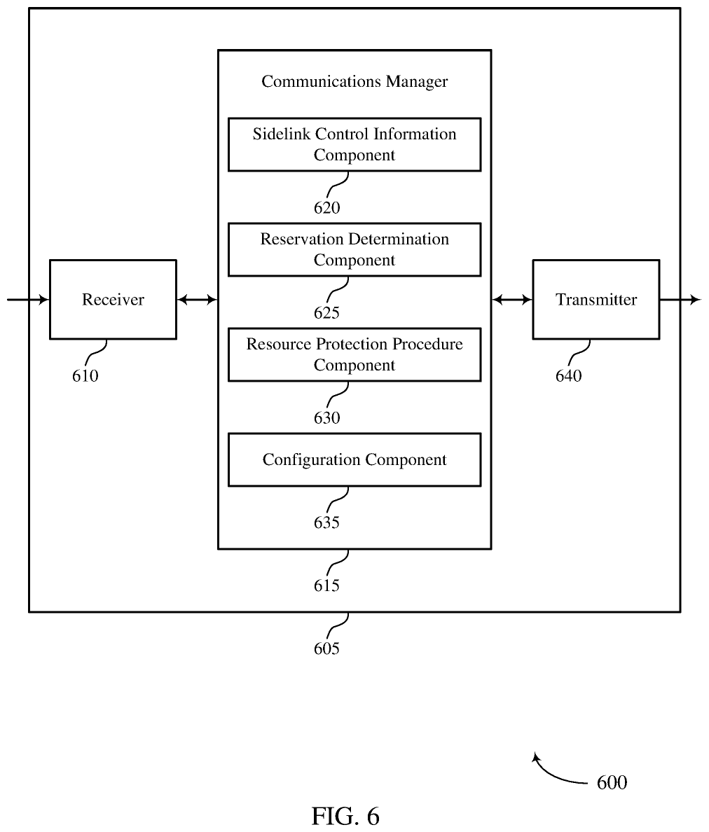

FIG. 6 shows a block diagram 600 of a device 605 that supports techniques for sidelink resource exclusion with a multi-TRP enabled transmitter in accordance with aspects of the present disclosure. The device 605 may be an example of aspects of a device 505, or a UE 115 as described herein. The device 605 may include a receiver 610, a communications manager 615, and a transmitter 640. The device 605 may also include a processor. Each of these components may be in communication with one another (e.g., via one or more buses).

The receiver 610 may receive information such as packets, user data, or control information associated with various information channels (e.g., control channels, data channels, and information related to techniques for sidelink resource exclusion with a multi-TRP enabled transmitter, etc.). Information may be passed on to other components of the device 605. The receiver 610 may be an example of aspects of the transceiver 820 described with reference to FIG. 8. The receiver 610 may utilize a single antenna or a set of antennas.

The communications manager 615 may be an example of aspects of the communications manager 515 as described herein. The communications manager 615 may include a sidelink control information component 620, a reservation determination component 625, a resource protection procedure component 630, and a configuration component 635. The communications manager 615 may be an example of aspects of the communications manager 810 described herein.

The sidelink control information component 620 may receive, from a second UE a sidelink control information transmission associated with a first TCI state over a sidelink channel. The reservation determination component 625 may determine that the sidelink control information transmission reserves time and frequency resources for a sidelink data transmission associated with a second TCI state, the second TCI state being different from the first TCI state. The resource protection procedure component 630 may selectively enable or disabling a resource protection procedure for the reserved time and frequency resources based on the determination and one or more of: a signal strength associated with the first TCI state or the second TCI state, a network congestion parameter, or a data priority associated with the sidelink data transmission.

The configuration component 635 may configure a sidelink control information transmission associated with a first TCI state to reserve time and frequency resources for a sidelink data transmission associated with a second TCI state, the sidelink control information transmission including an indication of the second TCI state. The sidelink control information component 620 may transmit, to a second UE the sidelink control information transmission associated with the first TCI state over a sidelink channel.

The transmitter 640 may transmit signals generated by other components of the device 605. In some examples, the transmitter 640 may be collocated with a receiver 610 in a transceiver module. For example, the transmitter 640 may be an example of aspects of the transceiver 820 described with reference to FIG. 8. The transmitter 640 may utilize a single antenna or a set of antennas.

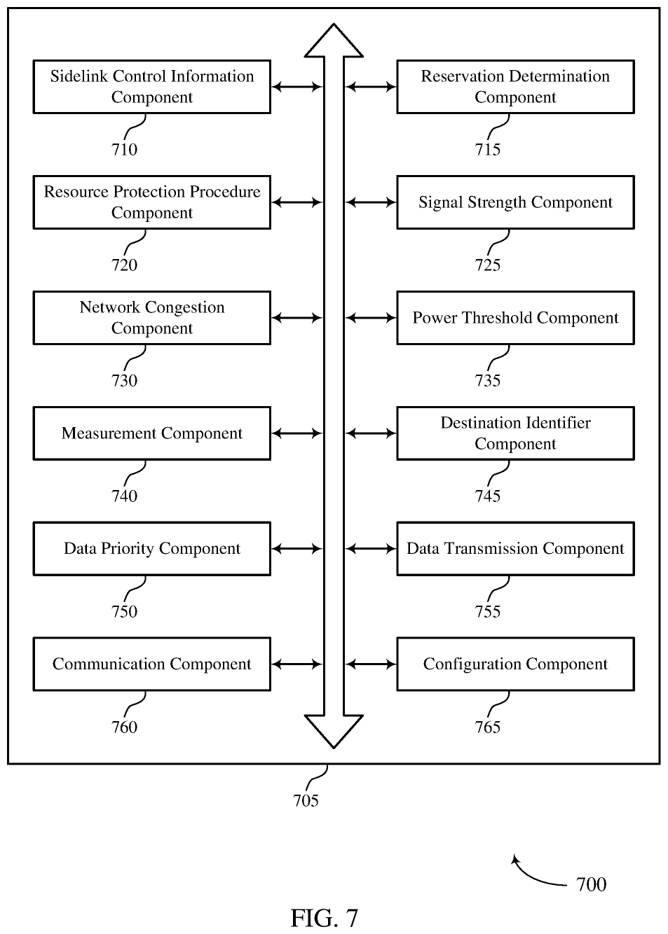

FIG. 7 shows a block diagram 700 of a communications manager 705 that supports techniques for sidelink resource exclusion with a multi-TRP enabled transmitter in accordance with aspects of the present disclosure. The communications manager 705 may be an example of aspects of a communications manager 515, a communications manager 615, or a communications manager 810 described herein. The communications manager 705 may include a sidelink control information component 710, a reservation determination component 715, a resource protection procedure component 720, a signal strength component 725, a network congestion component 730, a power threshold component 735, a measurement component 740, a destination identifier component 745, a data priority component 750, a data transmission component 755, a communication component 760, and a configuration component 765. Each of these modules may communicate, directly or indirectly, with one another (e.g., via one or more buses).

The sidelink control information component 710 may receive, from a second UE a sidelink control information transmission associated with a first TCI state over a sidelink channel. In some cases, the second UE includes a multi-TRP enabled transmitter.

The reservation determination component 715 may determine that the sidelink control information transmission reserves time and frequency resources for a sidelink data transmission associated with a second TCI state, the second TCI state being different from the first TCI state. The resource protection procedure component 720 may selectively enable or disabling a resource protection procedure for the reserved time and frequency resources based on the determination and one or more of: a signal strength associated with the first TCI state or the second TCI state, a network congestion parameter, or a data priority associated with the sidelink data transmission.

The signal strength component 725 may identify the signal strength associated with the second TCI state, the signal strength including a reference signal received power associated with the reserved time and frequency resources. In some examples, the resource protection procedure component 720 may determine that the reference signal received power satisfies a threshold, where selectively enabling or disabling the resource protection procedure includes disabling the resource protection procedure for the reserved time and frequency resources based on determining that the reference signal received power is greater than the threshold.

The network congestion component 730 may determine that the network congestion parameter associated with the sidelink channel satisfies a threshold, where selectively enabling or disabling the resource protection procedure includes disabling the resource protection procedure for the reserved time and frequency resources based on determining that the network congestion parameter associated with the sidelink channel satisfies the threshold.

The power threshold component 735 may identify a reference signal received power threshold associated with the reserved time and frequency resources, where selectively enabling or disabling the resource protection procedure includes enabling the resource protection procedure for the reserved time and frequency resources based on the reference signal received power threshold.

The measurement component 740 may perform one or more measurements on the sidelink control information transmission associated with the first TCI state, where selectively enabling or disabling the resource protection procedure includes enabling the resource protection procedure for the reserved time and frequency resources based on performing the one or more measurements on the sidelink control information transmission. In some cases, the one or more measurements include a reference signal received power measurement for the first TCI state.

In some examples, the sidelink control information component 710 may determine that the first TCI state is associated with a first TRP at the second UE and the second TCI state is associated with a second TRP at the second UE. In some examples, the resource protection procedure component 720 may determine a reference signal received power offset between the first TRP and the second TRP based on one or more prior transmissions received from the first TRP or the second TRP or both, where selectively enabling or disabling the resource protection procedure includes enabling the resource protection procedure for the reserved time and frequency resources based on the reference signal received power offset between the first TRP and the second TRP.

In some examples, the measurement component 740 may perform a reference signal received power measurement on the sidelink control information transmission associated with the first TCI state. In some examples, the measurement component 740 may adjust the reference signal received power measurement based on the reference signal received power offset, where the resource protection procedure is based on the adjusted reference signal received power measurement. In some cases, the one or more prior transmissions are received within a threshold time period prior to receiving the sidelink control information transmission associated with the first TCI state.

The destination identifier component 745 may determine whether a destination identifier for the sidelink control information transmission is same as a destination identifier for the one or more prior transmissions, where determining the reference signal received power offset is based on the destination identifier for the sidelink control information transmission being the same as the destination identifier for the one or more prior transmissions. In some cases, the one or more prior transmissions include at least one of broadcast transmissions, multicast transmissions, unicast transmissions, or a combination thereof.

In some examples, the measurement component 740 may perform a reference signal received power measurement on the sidelink control information transmission. In some examples, the resource protection procedure component 720 may determine a threshold for the resource protection procedure for an upcoming reservation of time and frequency resources associated with the second TCI state based on the reference signal received power measurement on the sidelink control information transmission. In some cases, the threshold includes a second reference signal received power greater than the measured reference signal received power.

The data priority component 750 may identify the data priority associated with the sidelink data transmission, where selectively enabling or disabling the resource protection procedure includes enabling the resource protection procedure for the reserved time and frequency resources based on the identified data priority. In some examples, the data priority component 750 may identify the data priority associated with the sidelink data transmission, where selectively enabling or disabling the resource protection procedure includes disabling the resource protection procedure for the reserved time and frequency resources based on determining that the identified data priority fails to satisfy a threshold.

The data transmission component 755 may determine that reception of the sidelink data transmission associated with the second TCI state is unsuccessful. In some examples, the resource protection procedure component 720 may determine a threshold for the resource protection procedure for an upcoming reservation of time and frequency resources associated with the second TCI state based on the unsuccessful reception of the sidelink data transmission, the threshold for the resource protection procedure for the upcoming reservation of time and frequency resources being greater than a threshold for the resource protection procedure for the reserved time and frequency resources.

In some examples, the data transmission component 755 may receive, from the second UE the sidelink data transmission associated with the second TCI state. In some examples, the resource protection procedure component 720 may determine a threshold for the resource protection procedure for an upcoming reservation of time and frequency resources associated with the second TCI state based on the successful reception of the sidelink data transmission.

In some examples, the resource protection procedure component 720 may disable the resource protection procedure for the reserved time and frequency resources. The communication component 760 may communicate over the reserved time and frequency resources based on disabling the resource protection procedure.

In some examples, the resource protection procedure component 720 may determine a threshold for the resource protection procedure for an upcoming reservation of time and frequency resources associated with the second TCI state based on disabling the resource protection procedure for the reserved time and frequency resources, the threshold for the resource protection procedure for the upcoming reservation of time and frequency resources being greater than a threshold for the resource protection procedure for the reserved time and frequency resources.

In some examples, the sidelink control information component 710 may identify one or more TCI state identifiers included in the sidelink control information transmission. In some examples, the reservation determination component 715 may determine that the sidelink control information transmission reserves time and frequency resources for the sidelink data transmission associated with the second TCI state based on the one or more TCI state identifiers.

In some examples, the sidelink control information component 710 may identify a bit included in the sidelink control information transmission. In some examples, the reservation determination component 715 may determine that the sidelink control information transmission reserves time and frequency resources for the sidelink data transmission associated with the second TCI state based on a value of the bit.

The configuration component 765 may configure a sidelink control information transmission associated with a first TCI state to reserve time and frequency resources for a sidelink data transmission associated with a second TCI state, the sidelink control information transmission including an indication of the second TCI state. In some examples, the sidelink control information component 710 may transmit, to a second UE the sidelink control information transmission associated with the first TCI state over a sidelink channel.

In some examples, the configuration component 765 may identify a TCI state identifier associated with the second TCI state. In some examples, the configuration component 765 may include the TCI state identifier in the sidelink control information transmission associated with the first TCI state.

In some examples, the configuration component 765 may include a bit in the sidelink control information transmission associated with the first TCI state, where a value of the bit includes an indication of reservation of the time and frequency resources for the sidelink data transmission associated with the second TCI state. In some cases, the first TCI state is associated with a first TRP at the first UE and the second TCI state is associated with a second TRP at the first UE. In some cases, the first UE includes a multi-TRP enabled transmitter.

FIG. 8 shows a diagram of a system 800 including a device 805 that supports techniques for sidelink resource exclusion with a multi-TRP enabled transmitter in accordance with aspects of the present disclosure. The device 805 may be an example of or include the components of device 505, device 605, or a UE 115 as described herein. The device 805 may include components for bi-directional voice and data communications including components for transmitting and receiving communications, including a communications manager 810, an I/O controller 815, a transceiver 820, an antenna 825, memory 830, and a processor 840. These components may be in electronic communication via one or more buses (e.g., bus 845).

The communications manager 810 may receive, from a second UE a sidelink control information transmission associated with a first TCI state over a sidelink channel, determine that the sidelink control information transmission reserves time and frequency resources for a sidelink data transmission associated with a second TCI state, the second TCI state being different from the first TCI state, and selectively enable or disabling a resource protection procedure for the reserved time and frequency resources based on the determination and one or more of: a signal strength associated with the first TCI state or the second TCI state, a network congestion parameter, or a data priority associated with the sidelink data transmission.

The communications manager 810 may also configure a sidelink control information transmission associated with a first TCI state to reserve time and frequency resources for a sidelink data transmission associated with a second TCI state, the sidelink control information transmission including an indication of the second TCI state and transmit, to a second UE the sidelink control information transmission associated with the first TCI state over a sidelink channel.

The I/O controller 815 may manage input and output signals for the device 805. The I/O controller 815 may also manage peripherals not integrated into the device 805. In some cases, the I/O controller 815 may represent a physical connection or port to an external peripheral. In some cases, the I/O controller 815 may utilize an operating system such as iOS®, ANDROID®, MS-DOS®, MS-WINDOWS®, OS/2®, UNIX®, LINUX®, or another known operating system. In other cases, the I/O controller 815 may represent or interact with a modem, a keyboard, a mouse, a touchscreen, or a similar device. In some cases, the I/O controller 815 may be implemented as part of a processor. In some cases, a user may interact with the device 805 via the I/O controller 815 or via hardware components controlled by the I/O controller 815.

The transceiver 820 may communicate bi-directionally, via one or more antennas, wired, or wireless links as described above. For example, the transceiver 820 may represent a wireless transceiver and may communicate bi-directionally with another wireless transceiver. The transceiver 820 may also include a modem to modulate the packets and provide the modulated packets to the antennas for transmission, and to demodulate packets received from the antennas.

In some cases, the wireless device may include a single antenna 825. However, in some cases the device may have more than one antenna 825, which may be capable of concurrently transmitting or receiving multiple wireless transmissions.

The memory 830 may include RAM and ROM. The memory 830 may store computer-readable, computer-executable code 835 including instructions that, when executed, cause the processor to perform various functions described herein. In some cases, the memory 830 may contain, among other things, a BIOS which may control basic hardware or software operation such as the interaction with peripheral components or devices.

The processor 840 may include an intelligent hardware device, (e.g., a general-purpose processor, a DSP, a CPU, a microcontroller, an ASIC, an FPGA, a programmable logic device, a discrete gate or transistor logic component, a discrete hardware component, or any combination thereof). In some cases, the processor 840 may be configured to operate a memory array using a memory controller. In other cases, a memory controller may be integrated into the processor 840. The processor 840 may be configured to execute computer-readable instructions stored in a memory (e.g., the memory 830) to cause the device 805 to perform various functions (e.g., functions or tasks supporting techniques for sidelink resource exclusion with a multi-TRP enabled transmitter).

The code 835 may include instructions to implement aspects of the present disclosure, including instructions to support wireless communications. The code 835 may be stored in a non-transitory computer-readable medium such as system memory or other type of memory. In some cases, the code 835 may not be directly executable by the processor 840 but may cause a computer (e.g., when compiled and executed) to perform functions described herein.

By including or configuring the communications manager 810 in accordance with examples as described herein, the device 805 may support improved techniques for directional sidelink transmission in the context of multi-TRP UEs 115. For example, by enabling the use of a sidelink control information associated with a first TCI state to reserve resources for a second TCI state, a quantity of sidelink transmissions and retransmissions may be reduced, thereby reducing network overhead, increasing coverage area, and improving efficiency. Moreover, by enabling resource exclusion procedures at a receiver UE 115, aspects of the present disclosure provides for reduced quantities of sidelink transmissions and retransmissions, thereby reducing processing resources at the multi-TRP UE 115 and the receiver UE 115, reducing power consumption, and improving battery performance.

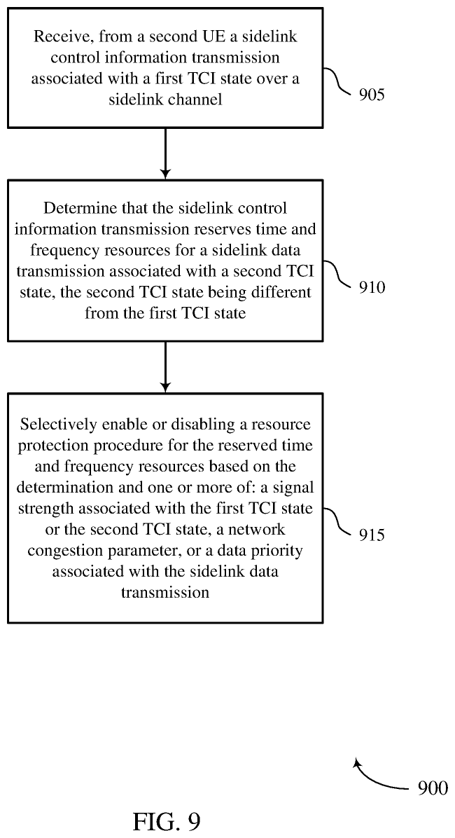

FIG. 9 shows a flowchart illustrating a method 900 that supports techniques for sidelink resource exclusion with a multi-TRP enabled transmitter in accordance with aspects of the present disclosure. The operations of method 900 may be implemented by a UE 115 or its components as described herein. For example, the operations of method 900 may be performed by a communications manager as described with reference to FIGS. 5 through 8. In some examples, a UE may execute a set of instructions to control the functional elements of the UE to perform the functions described below. Additionally or alternatively, a UE may perform aspects of the functions described below using special-purpose hardware.

At 905, the UE may receive, from a second UE a sidelink control information transmission associated with a first TCI state over a sidelink channel. The operations of 905 may be performed according to the methods described herein. In some examples, aspects of the operations of 905 may be performed by a sidelink control information component as described with reference to FIGS. 5 through 8.

At 910, the UE may determine that the sidelink control information transmission reserves time and frequency resources for a sidelink data transmission associated with a second TCI state, the second TCI state being different from the first TCI state. The operations of 910 may be performed according to the methods described herein. In some examples, aspects of the operations of 910 may be performed by a reservation determination component as described with reference to FIGS. 5 through 8.

At 915, the UE may selectively enable or disabling a resource protection procedure for the reserved time and frequency resources based on the determination and one or more of: a signal strength associated with the first TCI state or the second TCI state, a network congestion parameter, or a data priority associated with the sidelink data transmission. The operations of 915 may be performed according to the methods described herein. In some examples, aspects of the operations of 915 may be performed by a resource protection procedure component as described with reference to FIGS. 5 through 8.

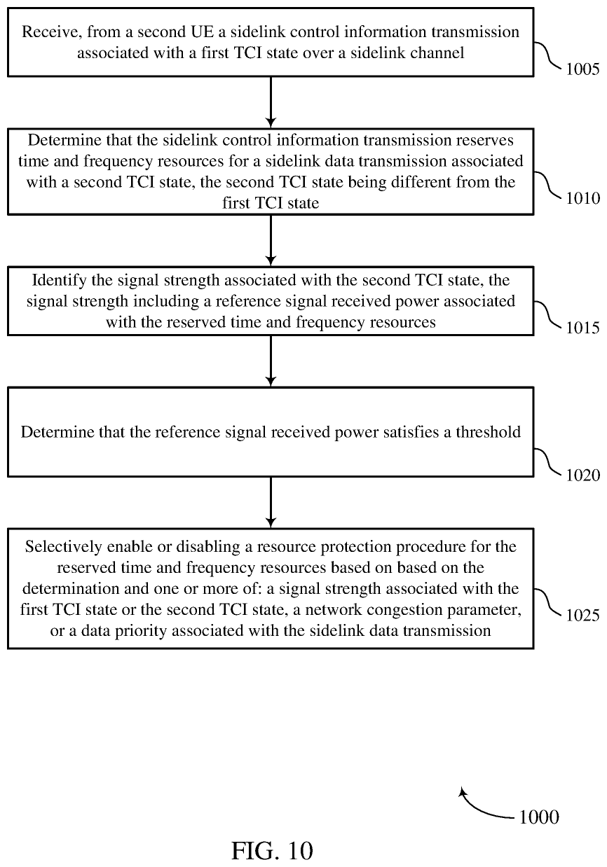

FIG. 10 shows a flowchart illustrating a method 1000 that supports techniques for sidelink resource exclusion with a multi-TRP enabled transmitter in accordance with aspects of the present disclosure. The operations of method 1000 may be implemented by a UE 115 or its components as described herein. For example, the operations of method 1000 may be performed by a communications manager as described with reference to FIGS. 5 through 8. In some examples, a UE may execute a set of instructions to control the functional elements of the UE to perform the functions described below. Additionally or alternatively, a UE may perform aspects of the functions described below using special-purpose hardware.

At 1005, the UE may receive, from a second UE a sidelink control information transmission associated with a first TCI state over a sidelink channel. The operations of 1005 may be performed according to the methods described herein. In some examples, aspects of the operations of 1005 may be performed by a sidelink control information component as described with reference to FIGS. 5 through 8.

At 1010, the UE may determine that the sidelink control information transmission reserves time and frequency resources for a sidelink data transmission associated with a second TCI state, the second TCI state being different from the first TCI state. The operations of 1010 may be performed according to the methods described herein. In some examples, aspects of the operations of 1010 may be performed by a reservation determination component as described with reference to FIGS. 5 through 8.

At 1015, the UE may identify the signal strength associated with the second TCI state, the signal strength including a reference signal received power associated with the reserved time and frequency resources. The operations of 1015 may be performed according to the methods described herein. In some examples, aspects of the operations of 1015 may be performed by a signal strength component as described with reference to FIGS. 5 through 8.

At 1020, the UE may determine that the reference signal received power satisfies a threshold. The operations of 1020 may be performed according to the methods described herein. In some examples, aspects of the operations of 1020 may be performed by a resource protection procedure component as described with reference to FIGS. 5 through 8.

At 1025, the UE may selectively enable or disabling a resource protection procedure for the reserved time and frequency resources based on the determination and one or more of: a signal strength associated with the first TCI state or the second TCI state, a network congestion parameter, or a data priority associated with the sidelink data transmission. In some examples, selectively enabling or disabling the resource protection procedure includes disabling the resource protection procedure for the reserved time and frequency resources based on determining that the reference signal received power is greater than the threshold. The operations of 1025 may be performed according to the methods described herein. In some examples, aspects of the operations of 1025 may be performed by a resource protection procedure component as described with reference to FIGS. 5 through 8.

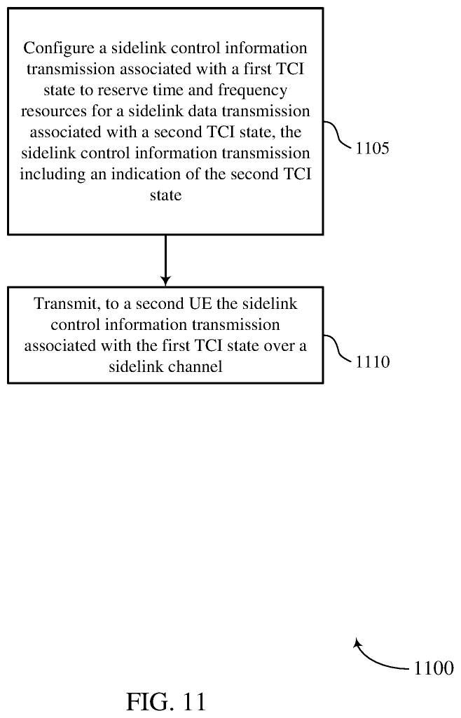

FIG. 11 shows a flowchart illustrating a method 1100 that supports techniques for sidelink resource exclusion with a multi-TRP enabled transmitter in accordance with aspects of the present disclosure. The operations of method 1100 may be implemented by a UE 115 or its components as described herein. For example, the operations of method 1100 may be performed by a communications manager as described with reference to FIGS. 5 through 8. In some examples, a UE may execute a set of instructions to control the functional elements of the UE to perform the functions described below. Additionally or alternatively, a UE may perform aspects of the functions described below using special-purpose hardware.

At 1105, the UE may configure a sidelink control information transmission associated with a first TCI state to reserve time and frequency resources for a sidelink data transmission associated with a second TCI state, the sidelink control information transmission including an indication of the second TCI state. The operations of 1105 may be performed according to the methods described herein. In some examples, aspects of the operations of 1105 may be performed by a configuration component as described with reference to FIGS. 5 through 8.

At 1110, the UE may transmit, to a second UE the sidelink control information transmission associated with the first TCI state over a sidelink channel. The operations of 1110 may be performed according to the methods described herein. In some examples, aspects of the operations of 1110 may be performed by a sidelink control information component as described with reference to FIGS. 5 through 8.

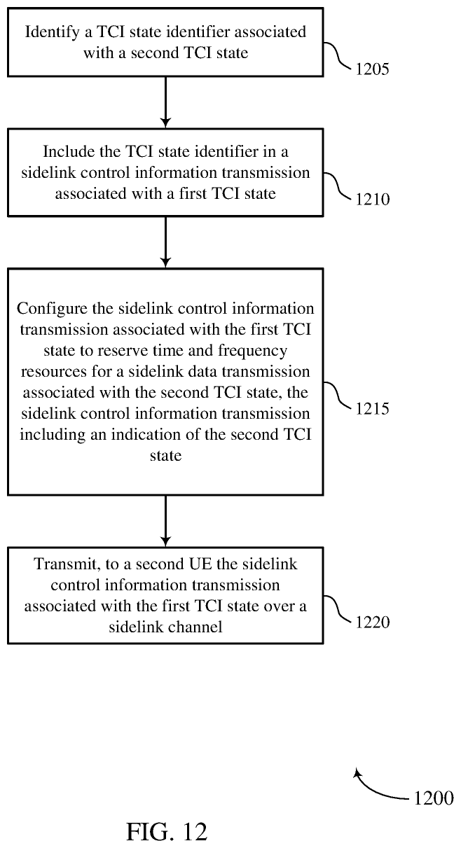

FIG. 12 shows a flowchart illustrating a method 1200 that supports techniques for sidelink resource exclusion with a multi-TRP enabled transmitter in accordance with aspects of the present disclosure. The operations of method 1200 may be implemented by a UE 115 or its components as described herein. For example, the operations of method 1200 may be performed by a communications manager as described with reference to FIGS. 5 through 8. In some examples, a UE may execute a set of instructions to control the functional elements of the UE to perform the functions described below. Additionally or alternatively, a UE may perform aspects of the functions described below using special-purpose hardware.

At 1205, the UE may identify a TCI state identifier associated with a second TCI state. The operations of 1205 may be performed according to the methods described herein. In some examples, aspects of the operations of 1205 may be performed by a configuration component as described with reference to FIGS. 5 through 8.

At 1210, the UE may include the TCI state identifier in a sidelink control information transmission associated with a first TCI state. The operations of 1210 may be performed according to the methods described herein. In some examples, aspects of the operations of 1210 may be performed by a configuration component as described with reference to FIGS. 5 through 8.

At 1215, the UE may configure the sidelink control information transmission associated with the first TCI state to reserve time and frequency resources for a sidelink data transmission associated with the second TCI state, the sidelink control information transmission including an indication of the second TCI state. The operations of 1215 may be performed according to the methods described herein. In some examples, aspects of the operations of 1215 may be performed by a configuration component as described with reference to FIGS. 5 through 8.

At 1220, the UE may transmit, to a second UE the sidelink control information transmission associated with the first TCI state over a sidelink channel. The operations of 1220 may be performed according to the methods described herein. In some examples, aspects of the operations of 1220 may be performed by a sidelink control information component as described with reference to FIGS. 5 through 8.

It should be noted that the methods described herein describe possible implementations, and that the operations and the steps may be rearranged or otherwise modified and that other implementations are possible. Further, aspects from two or more of the methods may be combined.

Although aspects of an LTE, LTE-A, LTE-A Pro, or NR system may be described for purposes of example, and LTE, LTE-A, LTE-A Pro, or NR terminology may be used in much of the description, the techniques described herein are applicable beyond LTE, LTE-A, LTE-A Pro, or NR networks. For example, the described techniques may be applicable to various other wireless communications systems such as Ultra Mobile Broadband (UMB), Institute of Electrical and Electronics Engineers (IEEE) 802.11 (Wi-Fi), IEEE 802.16 (WiMAX), IEEE 802.20, Flash-OFDM, as well as other systems and radio technologies not explicitly mentioned herein.

Information and signals described herein may be represented using any of a variety of different technologies and techniques. For example, data, instructions, commands, information, signals, bits, symbols, and chips that may be referenced throughout the description may be represented by voltages, currents, electromagnetic waves, magnetic fields or particles, optical fields or particles, or any combination thereof.

The various illustrative blocks and components described in connection with the disclosure herein may be implemented or performed with a general-purpose processor, a DSP, an ASIC, a CPU, an FPGA or other programmable logic device, discrete gate or transistor logic, discrete hardware components, or any combination thereof designed to perform the functions described herein. A general-purpose processor may be a microprocessor, but in the alternative, the processor may be any processor, controller, microcontroller, or state machine. A processor may also be implemented as a combination of computing devices (e.g., a combination of a DSP and a microprocessor, multiple microprocessors, one or more microprocessors in conjunction with a DSP core, or any other such configuration).

The functions described herein may be implemented in hardware, software executed by a processor, firmware, or any combination thereof. If implemented in software executed by a processor, the functions may be stored on or transmitted over as one or more instructions or code on a computer-readable medium. Other examples and implementations are within the scope of the disclosure and appended claims. For example, due to the nature of software, functions described herein may be implemented using software executed by a processor, hardware, firmware, hardwiring, or combinations of any of these. Features implementing functions may also be physically located at various positions, including being distributed such that portions of functions are implemented at different physical locations.

Computer-readable media includes both non-transitory computer storage media and communication media including any medium that facilitates transfer of a computer program from one place to another. A non-transitory storage medium may be any available medium that may be accessed by a general-purpose or special-purpose computer. By way of example, and not limitation, non-transitory computer-readable media may include random-access memory (RAM), read-only memory (ROM), electrically erasable programmable ROM (EEPROM), flash memory, compact disk (CD) ROM or other optical disk storage, magnetic disk storage or other magnetic storage devices, or any other non-transitory medium that may be used to carry or store desired program code means in the form of instructions or data structures and that may be accessed by a general-purpose or special-purpose computer, or a general-purpose or special-purpose processor. Also, any connection is properly termed a computer-readable medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of computer-readable medium. Disk and disc, as used herein, include CD, laser disc, optical disc, digital versatile disc (DVD), floppy disk and Blu-ray disc where disks usually reproduce data magnetically, while discs reproduce data optically with lasers. Combinations of the above are also included within the scope of computer-readable media.

As used herein, including in the claims, “or” as used in a list of items (e.g., a list of items prefaced by a phrase such as “at least one of” or “one or more of”) indicates an inclusive list such that, for example, a list of at least one of A, B, or C means A or B or C or AB or AC or BC or ABC (i.e., A and B and C). Also, as used herein, the phrase “based on” shall not be construed as a reference to a closed set of conditions. For example, an example step that is described as “based on condition A” may be based on both a condition A and a condition B without departing from the scope of the present disclosure. In other words, as used herein, the phrase “based on” shall be construed in the same manner as the phrase “based at least in part on.”

In the appended figures, similar components or features may have the same reference label. Further, various components of the same type may be distinguished by following the reference label by a dash and a second label that distinguishes among the similar components. If just the first reference label is used in the specification, the description is applicable to any one of the similar components having the same first reference label irrespective of the second reference label, or other subsequent reference label.

The description set forth herein, in connection with the appended drawings, describes example configurations and does not represent all the examples that may be implemented or that are within the scope of the claims. The term “example” used herein means “serving as an example, instance, or illustration,” and not “preferred” or “advantageous over other examples.” The detailed description includes specific details for the purpose of providing an understanding of the described techniques. These techniques, however, may be practiced without these specific details. In some instances, known structures and devices are shown in block diagram form in order to avoid obscuring the concepts of the described examples.

The description herein is provided to enable a person having ordinary skill in the art to make or use the disclosure. Various modifications to the disclosure will be apparent to a person having ordinary skill in the art, and the generic principles defined herein may be applied to other variations without departing from the scope of the disclosure. Thus, the disclosure is not limited to the examples and designs described herein, but is to be accorded the broadest scope consistent with the principles and novel features disclosed herein.

What is claimed is:

1. A method for wireless communication at a first user equipment (UE), comprising:
receiving, from a second UE a sidelink control information transmission associated with a first transmission configuration indicator (TCI) state over a sidelink channel;
determining that the sidelink control information transmission reserves time and frequency resources for a sidelink data transmission associated with a second TCI state, the second TCI state being different from the first TCI state; and
selectively enabling or disabling a resource protection procedure for the reserved time and frequency resources based at least in part on the determination and one or more of: a signal strength associated with the first TCI state or the second TCI state, a network congestion parameter, or a data priority associated with the sidelink data transmission.

2. The method of claim 1, further comprising:
identifying the signal strength associated with the second TCI state, the signal strength comprising a reference signal received power associated with the reserved time and frequency resources; and
determining that the reference signal received power satisfies a threshold, wherein selectively enabling or disabling the resource protection procedure comprises disabling the resource protection procedure for the reserved time and frequency resources based at least in part on determining that the reference signal received power is greater than the threshold.

3. The method of claim 1, further comprising:
determining that the network congestion parameter associated with the sidelink channel satisfies a threshold, wherein selectively enabling or disabling the resource protection procedure comprises disabling the resource protection procedure for the reserved time and frequency resources based at least in part on determining that the network congestion parameter associated with the sidelink channel satisfies the threshold.

4. The method of claim 1, further comprising:
identifying a reference signal received power threshold associated with the reserved time and frequency resources, wherein selectively enabling or disabling the resource protection procedure comprises enabling the resource protection procedure for the reserved time and frequency resources based at least in part on the reference signal received power threshold.

5. The method of claim 1, further comprising:
performing one or more measurements on the sidelink control information transmission associated with the first TCI state, wherein selectively enabling or disabling the resource protection procedure comprises enabling the resource protection procedure for the reserved time and frequency resources based at least in part on performing the one or more measurements on the sidelink control information transmission.

6. The method of claim 5, wherein the one or more measurements comprise a reference signal received power measurement for the first TCI state.

7. The method of claim 1, further comprising:
determining that the first TCI state is associated with a first transmission and receive point (TRP) at the second UE and the second TCI state is associated with a second TRP at the second UE; and
determining a reference signal received power offset between the first TRP and the second TRP based at least in part on one or more prior transmissions received from the first TRP or the second TRP or both, wherein selectively enabling or disabling the resource protection procedure comprises enabling the resource protection procedure for the reserved time and frequency resources based at least in part on the reference signal received power offset between the first TRP and the second TRP.

8. The method of claim 7, further comprising:
performing a reference signal received power measurement on the sidelink control information transmission associated with the first TCI state; and
adjusting the reference signal received power measurement based at least in part on the reference signal received power offset, wherein the resource protection procedure is based at least in part on the adjusted reference signal received power measurement.

9. The method of claim 7, wherein the one or more prior transmissions are received within a threshold time period prior to receiving the sidelink control information transmission associated with the first TCI state.

10. The method of claim 7, further comprising:
determining whether a destination identifier for the sidelink control information transmission is same as a destination identifier for the one or more prior transmissions, wherein determining the reference signal received power offset is based at least in part on the destination identifier for the sidelink control information transmission being the same as the destination identifier for the one or more prior transmissions.

11. The method of claim 7, wherein the one or more prior transmissions comprise at least one of broadcast transmissions, multicast transmissions, unicast transmissions, or a combination thereof.

12. The method of claim 1, further comprising:
performing a reference signal received power measurement on the sidelink control information transmission; and
determining a threshold for the resource protection procedure for an upcoming reservation of time and frequency resources associated with the second TCI state based at least in part on the reference signal received power measurement on the sidelink control information transmission.

13. The method of claim 12, wherein the threshold comprises a second reference signal received power greater than the measured reference signal received power.

14. The method of claim 1, further comprising:
identifying the data priority associated with the sidelink data transmission, wherein selectively enabling or disabling the resource protection procedure comprises enabling the resource protection procedure for the reserved time and frequency resources based at least in part on the identified data priority.

15. The method of claim 1, further comprising:
identifying the data priority associated with the sidelink data transmission, wherein selectively enabling or disabling the resource protection procedure comprises disabling the resource protection procedure for the reserved time and frequency resources based at least in part on determining that the identified data priority fails to satisfy a threshold.

16. The method of claim 1, further comprising:
determining that reception of the sidelink data transmission associated with the second TCI state is unsuccessful; and
determining a threshold for the resource protection procedure for an upcoming reservation of time and frequency resources associated with the second TCI state based at least in part on the unsuccessful reception of the sidelink data transmission, the threshold for the resource protection procedure for the upcoming reservation of time and frequency resources being greater than a threshold for the resource protection procedure for the reserved time and frequency resources.

17. The method of claim 1, further comprising:
receiving, from the second UE the sidelink data transmission associated with the second TCI state; and
determining a threshold for the resource protection procedure for an upcoming reservation of time and frequency resources associated with the second TCI state based at least in part on the successful reception of the sidelink data transmission.

18. The method of claim 1, further comprising:
disabling the resource protection procedure for the reserved time and frequency resources; and
communicating over the reserved time and frequency resources based at least in part on disabling the resource protection procedure.

19. The method of claim 18, further comprising:
determining a threshold for the resource protection procedure for an upcoming reservation of time and frequency resources associated with the second TCI state based at least in part on disabling the resource protection procedure for the reserved time and frequency resources, the threshold for the resource protection procedure for the upcoming reservation of time and frequency resources being greater than a threshold for the resource protection procedure for the reserved time and frequency resources.

20. The method of claim 1, further comprising:
identifying one or more TCI state identifiers included in the sidelink control information transmission; and
determining that the sidelink control information transmission reserves time and frequency resources for the sidelink data transmission associated with the second TCI state based at least in part on the one or more TCI state identifiers.

21. The method of claim 1, further comprising:
identifying a bit included in the sidelink control information transmission; and
determining that the sidelink control information transmission reserves time and frequency resources for the sidelink data transmission associated with the second TCI state based at least in part on a value of the bit.

22. The method of claim 1, wherein the second UE comprises a multi-transmission and receive point enabled transmitter.

23. A method for wireless communication at a first user equipment (UE), comprising:
configuring a sidelink control information transmission associated with a first transmission configuration indicator (TCI) state to reserve time and frequency resources for a sidelink data transmission associated with a second TCI state, the sidelink control information transmission comprising an indication of the second TCI state; and
transmitting, to a second UE the sidelink control information transmission associated with the first TCI state over a sidelink channel.

24. The method of claim 23, wherein configuring the sidelink control information transmission comprises:
identifying a TCI state identifier associated with the second TCI state; and
including the TCI state identifier in the sidelink control information transmission associated with the first TCI state.

25. The method of claim 23, wherein configuring the sidelink control information transmission comprises:
including a bit in the sidelink control information transmission associated with the first TCI state, wherein a value of the bit comprises an indication of reservation of the time and frequency resources for the sidelink data transmission associated with the second TCI state.

26. The method of claim 23, wherein the first TCI state is associated with a first transmission and receive point (TRP) at the first UE and the second TCI state is associated with a second TRP at the first UE.

27. The method of claim 23, wherein the first UE comprises a multi-transmission and receive point enabled transmitter.

28. An apparatus for wireless communication at a first user equipment (UE), comprising:
a processor,
memory coupled with the processor; and
instructions stored in the memory and executable by the processor to cause the apparatus to:
receive, from a second UE a sidelink control information transmission associated with a first transmission configuration indicator (TCI) state over a sidelink channel;
determine that the sidelink control information transmission reserves time and frequency resources for a sidelink data transmission associated with a second TCI state, the second TCI state being different from the first TCI state; and
selectively enable or disabling a resource protection procedure for the reserved time and frequency resources based at least in part on the determination and one or more of: a signal strength associated with the first TCI state or the second TCI state, a network congestion parameter, or a data priority associated with the sidelink data transmission.

29. The apparatus of claim 28, wherein the instructions are further executable by the processor to cause the apparatus to:
identify the signal strength associated with the second TCI state, the signal strength comprising a reference signal received power associated with the reserved time and frequency resources; and
the instructions to determine that the reference signal received power satisfies a threshold, wherein selectively enabling or disabling the resource protection procedure are executable by the processor to cause the apparatus to disable the resource protection procedure for the reserved time and frequency resources based at least in part on determining that the reference signal received power is greater than the threshold.

30. The apparatus of claim 28, wherein the instructions are further executable by the processor to cause the apparatus to:
the instructions to determine that the network congestion parameter associated with the sidelink channel satisfies a threshold, wherein selectively enabling or disabling the resource protection procedure are executable by the processor to cause the apparatus to disable the resource protection procedure for the reserved time and frequency resources based at least in part on determining that the network congestion parameter associated with the sidelink channel satisfies the threshold.

31. The apparatus of claim 28, wherein the instructions are further executable by the processor to cause the apparatus to:
the instructions to identify a reference signal received power threshold associated with the reserved time and frequency resources, wherein selectively enabling or disabling the resource protection procedure are executable by the processor to cause the apparatus to enable the resource protection procedure for the reserved time and frequency resources based at least in part on the reference signal received power threshold.

32. The apparatus of claim 28, wherein the instructions are further executable by the processor to cause the apparatus to:
the instructions to perform one or more measurements on the sidelink control information transmission associated with the first TCI state, wherein selectively enabling or disabling the resource protection procedure are executable by the processor to cause the apparatus to enable the resource protection procedure for the reserved time and frequency resources based at least in part on performing the one or more measurements on the sidelink control information transmission.

33. The apparatus of claim 32, wherein the one or more measurements comprise a reference signal received power measurement for the first TCI state.

34. The apparatus of claim 28, wherein the instructions are further executable by the processor to cause the apparatus to:
determine that the first TCI state is associated with a first transmission and receive point (TRP) at the second UE and the second TCI state is associated with a second TRP at the second UE; and
the instructions to determine a reference signal received power offset between the first TRP and the second TRP based at least in part on one or more prior transmissions received from the first TRP or the second TRP or both, wherein selectively enabling or disabling the resource protection procedure are executable by the processor to cause the apparatus to enable the resource protection procedure for the reserved time and frequency resources based at least in part on the reference signal received power offset between the first TRP and the second TRP.

35. The apparatus of claim 34, wherein the instructions are further executable by the processor to cause the apparatus to:
perform a reference signal received power measurement on the sidelink control information transmission associated with the first TCI state; and
adjust the reference signal received power measurement based at least in part on the reference signal received power offset, wherein the resource protection procedure is based at least in part on the adjusted reference signal received power measurement.

36. The apparatus of claim 34, wherein the one or more prior transmissions are received within a threshold time period prior to receiving the sidelink control information transmission associated with the first TCI state.

37. The apparatus of claim 34, wherein the instructions are further executable by the processor to cause the apparatus to:
determine whether a destination identifier for the sidelink control information transmission is same as a destination identifier for the one or more prior transmissions, wherein determining the reference signal received power offset is based at least in part on the destination identifier for the sidelink control information transmission being the same as the destination identifier for the one or more prior transmissions.

38. The apparatus of claim 34, wherein the one or more prior transmissions comprise at least one of broadcast transmissions, multicast transmissions, unicast transmissions, or a combination thereof.

39. The apparatus of claim 28, wherein the instructions are further executable by the processor to cause the apparatus to:
perform a reference signal received power measurement on the sidelink control information transmission; and
determine a threshold for the resource protection procedure for an upcoming reservation of time and frequency resources associated with the second TCI state based at least in part on the reference signal received power measurement on the sidelink control information transmission.

40. The apparatus of claim 39, wherein the threshold comprises a second reference signal received power greater than the measured reference signal received power.

41. The apparatus of claim 28, wherein the instructions are further executable by the processor to cause the apparatus to:
the instructions to identify the data priority associated with the sidelink data transmission, wherein selectively enabling or disabling the resource protection procedure are executable by the processor to cause the apparatus to enable the resource protection procedure for the reserved time and frequency resources based at least in part on the identified data priority.

42. The apparatus of claim 28, wherein the instructions are further executable by the processor to cause the apparatus to:
the instructions to identify the data priority associated with the sidelink data transmission, wherein selectively enabling or disabling the resource protection procedure are executable by the processor to cause the apparatus to disable the resource protection procedure for the reserved time and frequency resources based at least in part on determining that the identified data priority fails to satisfy a threshold.

43. The apparatus of claim 28, wherein the instructions are further executable by the processor to cause the apparatus to:
determine that reception of the sidelink data transmission associated with the second TCI state is unsuccessful; and
determine a threshold for the resource protection procedure for an upcoming reservation of time and frequency resources associated with the second TCI state based at least in part on the unsuccessful reception of the sidelink data transmission, the threshold for the resource protection procedure for the upcoming reservation of time and frequency resources being greater than a threshold for the resource protection procedure for the reserved time and frequency resources.

44. The apparatus of claim 28, wherein the instructions are further executable by the processor to cause the apparatus to:
receive, from the second UE the sidelink data transmission associated with the second TCI state; and
determine a threshold for the resource protection procedure for an upcoming reservation of time and frequency resources associated with the second TCI state based at least in part on the successful reception of the sidelink data transmission.

45. The apparatus of claim 28, wherein the instructions are further executable by the processor to cause the apparatus to:
disable the resource protection procedure for the reserved time and frequency resources; and
communicate over the reserved time and frequency resources based at least in part on disabling the resource protection procedure.

46. The apparatus of claim 45, wherein the instructions are further executable by the processor to cause the apparatus to:
determine a threshold for the resource protection procedure for an upcoming reservation of time and frequency resources associated with the second TCI state based at least in part on disabling the resource protection procedure for the reserved time and frequency resources, the threshold for the resource protection procedure for the upcoming reservation of time and frequency resources being greater than a threshold for the resource protection procedure for the reserved time and frequency resources.

47. The apparatus of claim 28, wherein the instructions are further executable by the processor to cause the apparatus to:
identify one or more TCI state identifiers included in the sidelink control information transmission; and
determine that the sidelink control information transmission reserves time and frequency resources for the sidelink data transmission associated with the second TCI state based at least in part on the one or more TCI state identifiers.

48. The apparatus of claim 28, wherein the instructions are further executable by the processor to cause the apparatus to:
identify a bit included in the sidelink control information transmission; and
determine that the sidelink control information transmission reserves time and frequency resources for the sidelink data transmission associated with the second TCI state based at least in part on a value of the bit.

49. The apparatus of claim 28, wherein the second UE comprises a multi-transmission and receive point enabled transmitter.

50. An apparatus for wireless communication at a first user equipment (UE), comprising:
a processor,
memory coupled with the processor; and
instructions stored in the memory and executable by the processor to cause the apparatus to:
configure a sidelink control information transmission associated with a first transmission configuration indicator (TCI) state to reserve time and frequency resources for a sidelink data transmission associated with a second TCI state, the sidelink control information transmission comprising an indication of the second TCI state; and
transmit, to a second UE the sidelink control information transmission associated with the first TCI state over a sidelink channel.

51. The apparatus of claim 50, wherein the instructions to configure the sidelink control information transmission are executable by the processor to cause the apparatus to:
identify a TCI state identifier associated with the second TCI state; and
include the TCI state identifier in the sidelink control information transmission associated with the first TCI state.

52. The apparatus of claim 50, wherein the instructions to configure the sidelink control information transmission are executable by the processor to cause the apparatus to:
include a bit in the sidelink control information transmission associated with the first TCI state, wherein a value of the bit comprises an indication of reservation of the time and frequency resources for the sidelink data transmission associated with the second TCI state.

53. The apparatus of claim 50, wherein the first TCI state is associated with a first transmission and receive point (TRP) at the first UE and the second TCI state is associated with a second TRP at the first UE.

54. The apparatus of claim 50, wherein the first UE comprises a multi-transmission and receive point enabled transmitter.

55. An apparatus for wireless communication at a first user equipment (UE), comprising:
means for receiving, from a second UE a sidelink control information transmission associated with a first transmission configuration indicator (TCI) state over a sidelink channel;
means for determining that the sidelink control information transmission reserves time and frequency resources for a sidelink data transmission associated with a second TCI state, the second TCI state being different from the first TCI state; and
means for selectively enabling or disabling a resource protection procedure for the reserved time and frequency resources based at least in part on the determination and one or more of: a signal strength associated with the first TCI state or the second TCI state, a network congestion parameter, or a data priority associated with the sidelink data transmission.

56. An apparatus for wireless communication at a first user equipment (UE), comprising:
means for configuring a sidelink control information transmission associated with a first transmission configuration indicator (TCI) state to reserve time and frequency resources for a sidelink data transmission associated with a second TCI state, the sidelink control information transmission comprising an indication of the second TCI state; and
means for transmitting, to a second UE the sidelink control information transmission associated with the first TCI state over a sidelink channel.

57. A non-transitory computer-readable medium storing code for wireless communication at a first user equipment (UE), the code comprising instructions executable by a processor to:
receive, from a second UE a sidelink control information transmission associated with a first transmission configuration indicator (TCI) state over a sidelink channel;
determine that the sidelink control information transmission reserves time and frequency resources for a sidelink data transmission associated with a second TCI state, the second TCI state being different from the first TCI state; and
selectively enable or disabling a resource protection procedure for the reserved time and frequency resources based at least in part on the determination and one or more of: a signal strength associated with the first TCI state or the second TCI state, a network congestion parameter, or a data priority associated with the sidelink data transmission.

58. A non-transitory computer-readable medium storing code for wireless communication at a first user equipment (UE), the code comprising instructions executable by a processor to:
configure a sidelink control information transmission associated with a first transmission configuration indicator (TCI) state to reserve time and frequency resources for a sidelink data transmission associated with a second TCI state, the sidelink control information transmission comprising an indication of the second TCI state; and
transmit, to a second UE the sidelink control information transmission associated with the first TCI state over a sidelink channel.
